(19) United States
(12) Patent Application Publication
(10) Pub. No.: US 2026/0213811 A1
(43) Pub. Date: Jul. 23, 2026

(54) TIME-CONSTANT AND TIME-VARYING SPLIT FOR DOPPLER CHANNEL STATE INFORMATION

(71) Applicant: QUALCOMM Incorporated, San Diego, CA (US)

(72) Inventors: Jing DAI, Beijing (CN); Liangming WU, Beijing (CN); Min HUANG, Beijing (CN)

(21) Appl. No.: 19/157,311

(22) PCT Filed: Apr. 7, 2023
(86) PCT No.: PCT/CN2023/086862

§ 371 Date: Aug. 15, 2025

(51) Int. Cl. H04B 7/06; H04W 72/0453

(52) U.S. Cl. CPC H04B 7/0626; H04B 7/0632; H04W 72/0453

(57) ABSTRACT

Various aspects of the present disclosure generally relate to wireless communication. For example, time-variant channel state information (CSI) content may be associated with group 2 of CSI part 2 such that the time-variant CSI content may be omitted from CSI part 2 first. Some aspects more specifically relate to associating content related to a Doppler domain basis selection, a coefficient quantization and/or non-zero coefficient selection bitmap associated with a Doppler domain basis with an index greater than zero, and/or content related to a channel quality indicator for slots other than a first slot in a CSI window with CSI part 2, group 2. Accordingly, in cases where an uplink resource allocation for CSI part 2 is insufficient for all of the CSI content that the UE extrapolates for the CSI window, the time-variant CSI content associated with group 2 of CSI part 2 may be packed last and/or omitted first.

### FIELD OF THE DISCLOSURE

Aspects of the present disclosure generally relate to wireless communication and specifically, to techniques and apparatuses associated with a time-constant and time-varying split for Doppler channel state information (CSI).

### BACKGROUND

Wireless communication systems are widely deployed to provide various telecommunication services such as telephony, video, data, messaging, and broadcasts. Typical wireless communication systems may employ multiple-access radio access technologies (RATs) capable of supporting communication with multiple users by sharing available system resources (for example, bandwidth or transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access technologies have been adopted in various telecommunication standards to provide a common protocol that enables different wireless communication devices to communicate on a municipal, national, regional, or global level. An example telecommunication standard is New Radio (NR). NR, which may also be referred to as 5G, is part of a continuous mobile broadband evolution promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in NR may be implemented, and other radio access technologies such as 6G may be introduced to further advance mobile broadband evolution.

A user equipment (UE) may report channel state information (CSI) feedback associated with a channel between the UE and a network node. For example, one feature of 5G systems is the use of MIMO transmission schemes to achieve high system throughput compared to previous generations of mobile systems. MIMO transmission generally requires the availability of accurate CSI used at a network node for a signal precoding using a precoding matrix of the data and control information. A comprehensive framework for CSI reporting may be defined, such as by a wireless communication standard such as the 3GPP. The CSI is acquired in a first step at the UE based on the UE receiving CSI reference signals (CSI-RSs) from a network node. In a second step, the UE may determine a precoding matrix (for example, based on an estimated channel matrix) from a predefined set of matrices referred to as a “codebook.” The selected precoding matrix is reported by the UE (for example, in a CSI report) in a third step in the form of a precoding matrix indicator (PMI) and rank indicator (RI).

In some examples, a UE may drop some parts of one or more CSI report(s) in an example where an uplink resource allocation (for example, a physical uplink shared channel (PUSCH) resource allocation) is not sufficient to carry the entire contents of the CSI report(s). Such scenarios may occur when a network node did not accurately allocate the PUSCH resources when scheduling the one or more CSI report(s). In such examples, the UE may drop a portion of the CSI, such as information associated with the one or more CSI report(s) (which may be referred to as uplink control information (UCI) omission or CSI omission). For example, the UE may transmit UCI carrying one or more CSI reports via the uplink resource allocation. UCI omission may be achieved by decomposing the contents of the CSI reports into groups associated with different priority levels. Each priority level may be associated with a group that is associated with a CSI report. The UE may drop information associated with one or more groups with lower priorities such that a total payload size of the UCI (for example, including the one or more CSI report(s)) fits within the uplink resource allocation (for example, the PUSCH resource allocation) for the UCI. For example, a UCI packing order (for example, indicating an order in which information is to be included in a given CSI report) or a UCI omission order (for example, indicating an order in which information associated with all CSI reports to be included in a UCI transmission is to be dropped) may be defined by the priority levels of respective groups associated with the one or more CSI report(s).

In some examples, a UE may move at medium or high velocities. In such examples, channel conditions associated with the UE may vary rapidly over time. As a result, a precoding matrix associated with the channel and the UE may vary rapidly over time. To handle the changing precoding matrix, a time domain basis codebook may be used by the UE for reporting CSI (for example, for reporting a PMI). For example, in addition to frequency domain bases and spatial domain bases, the precoding matrix associated with CSI report(s) may be associated with time domain bases. The introduction of the time domain basis codebook (or a Doppler domain basis codebook) may provide beneficial CSI information (for example, a PMI) in medium or high velocity scenarios. For example, because a UE may include time domain bases and coefficients (for example, non-zero coefficients (NZCs) of a coefficient matrix of the time domain basis codebook) in a CSI report transmitted to a network node, the network node may be enabled to predict CSI or a precoding matrix for one or more future slots based on extrapolated time domain bases and coefficients indicated by the UE. This may improve communication performance in medium or high velocity scenarios where channel conditions associated with the UE may change rapidly.

In some examples, the UE may perform UCI omission, as described above, in accordance with the UCI packing order or the UCI omission order (for example, that are defined by priority levels of respective groups associated with CSI report(s), as described above). However, in some cases, the UCI omission order may cause the UE to include coefficients associated with a Doppler domain basis with index 0 and to omit coefficients associated with a Doppler domain basis with an index greater than 0. In such cases, when the network node only receives the coefficients related to the Doppler domain basis with index 0 due to the UCI omission order, the coefficients are generally considered time-constant (similar to legacy CSI that is considered to be constant over time). Accordingly, in such cases, including certain content that is time-variant or otherwise specific to the time domain in the CSI part 2, such as extrapolated or predicted precoders associated with a future time window, may result in unnecessary overhead.

### SUMMARY

Some aspects described herein relate to a user equipment (UE) for wireless communication. The UE may include at least one memory and at least one processor coupled with the at least one memory. The at least one processor may be operable to cause the UE to receive a channel state information (CSI) reference signal (CSI-RS) in each of a plurality of CSI-RS occasions. The at least one processor may be operable to cause the UE to transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

Some aspects described herein relate to a method of wireless communication performed by a UE. The method may include receiving a CSI-RS in each of a plurality of CSI-RS occasions. The method may include transmitting, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

Some aspects described herein relate to a non-transitory computer-readable medium that stores a set of instructions for wireless communication by a UE. The set of instructions, when executed by one or more processors of the UE, may cause the UE to receive a CSI-RS in each of a plurality of CSI-RS occasions. The set of instructions, when executed by one or more processors of the UE, may cause the UE to transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

Some aspects described herein relate to an apparatus for wireless communication. The apparatus may include means for receiving a CSI-RS in each of a plurality of CSI-RS occasions. The apparatus may include means for transmitting, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIGS. 3A-3C are diagrams illustrating examples of codebook structures that may be used to report Doppler channel state information (CSI) in accordance with the present disclosure.

FIG. 4 is a diagram illustrating an example of a CSI window in a time domain in accordance with the present disclosure.

FIG. 5 is a diagram illustrating an example of CSI packing and prioritization, in accordance with the present disclosure.

FIG. 6 is a diagram illustrating an example of priority ordering for a coefficient matrix in accordance with the present disclosure.

FIGS. 7A-7C are diagrams illustrating an example of a time-constant and time-varying split for Doppler CSI in accordance with the present disclosure.

FIG. 8 is a flowchart illustrating an example process performed, for example, by a UE that supports a time-constant and time-varying split for Doppler CSI in accordance with the present disclosure.

FIG. 9 is a diagram of an example apparatus for wireless communication that supports a time-constant and time-varying split for Doppler CSI.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to associating CSI content associated with a time domain (for example, time-variant channel state information (CSI)) and/or CSI content that is independent of a time domain (for example, time-constant CSI) with CSI part 1 and/or different groups within CSI part 2, such that certain time-variant CSI content may be omitted from CSI part 2 first (for example, when a user equipment (UE) only reports coefficients related to a Doppler domain with index 0, or time-constant CSI, to a network node). Some aspects more specifically relate to associating content related to a Doppler domain basis selection, content related to a \tilde{W}₂ coefficient quantization associated with a Doppler domain basis with an index greater than 0, content related to a \tilde{W}₂ non-zero coefficient (NZC) selection bitmap associated with a Doppler domain basis index greater than 0, and/or content related to a channel quality indicator (CQI) for a slot other than the first slot of a CSI window with group 2 of CSI part 2. In some examples, in cases where an uplink resource allocation for CSI part 2 is insufficient to carry all of the CSI content that the UE extrapolates or predicts for the CSI window, the time-variant CSI content associated with group 2 of CSI part 2 may be packed last and/or omitted first. Furthermore, in some examples, some extrapolated or predicted CSI content may be included in group 1 of CSI part 2, or group 0 of CSI part 2, or in CSI part 1, depending on the relative importance, relevance, and/or payload size of the CSI content.

Particular aspects of the subject matter described in this disclosure can be implemented to realize one or more of the following potential advantages. In some examples, the described techniques can be used to reduce the overhead associated with a CSI report in which some CSI content is time-constant (for example, associated with a Doppler domain basis selection with index 0) and/or certain time-variant CSI content is omitted from the CSI report (for example, CSI content associated with a Doppler domain basis selection with an index greater than 0). For example, when the UE omits time-variant CSI content from the CSI report in accordance with one or more CSI omission rules due to an uplink resource allocation being insufficient to carry all of the content associated with CSI part 2, payloads to carry the time-variant content that is only relevant to future Doppler domain bases may be omitted from the CSI report may be wasteful (for example, are not usable by the network node because the relevant coefficients were omitted). In this way, associating the time-variant CSI content with group 2 of CSI part 2 may result in the time-variant CSI content being omitted first, which may conserve resources that would otherwise be wasted by conveying the irrelevant time-varying content from the UE to the network node.

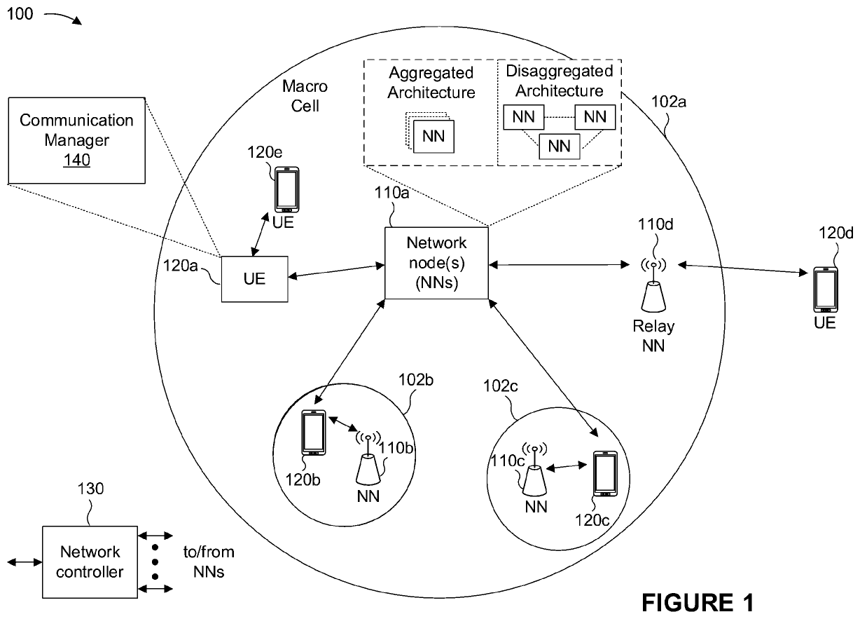

FIG. 1 is a diagram illustrating an example of a wireless network 100 in accordance with the present disclosure. The wireless network 100 may be or may include elements of a 5G (for example, NR) network or a 6G network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), and/or other network entities.

A network node 110 may include one or more devices that enable communication between a UE 120 and the wireless network 100. A network node 110 may include, for example, an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or a radio access network (RAN) node. As shown, a network node 110 may include one or more network nodes. In some aspects, a network node 110 may be an aggregated network node, meaning that the network node 110 may utilize a radio protocol stack that is physically and/or logically integrated within a single RAN node. For example, a network node 110 (an aggregated network node) may include a single standalone base station or a single TRP that may utilize a radio protocol stack (such as a full gNB protocol stack) to facilitate communication between a UE 120 and a core network associated with the wireless network 100.

In some aspects, a network node 110 may be a disaggregated network node (sometimes referred to as a disaggregated base station), meaning that the network node 110 may utilize a protocol stack that is physically distributed and/or logically distributed among two or more nodes in the same geographic location or in different geographic locations. For example, a network node 110 may include one of, or a combination of, one or more central units (CUs), one or more distributed units (DUs), one or more radio units (RUs), one or more integrated access and backhaul (IAB) nodes, one or more Near-Real Time (Near-RT) RAN Intelligent Controllers (RICs), and/or a Non-Real Time (Non-RT) RICs in the wireless network 100. For example, “a/the network node 110” may refer to a node that implements part of a protocol stack, a node that implements a full protocol stack, or a collection of nodes that collectively implement the protocol stack. In some cases a CU, a DU, and/or an RU may be implemented as a virtual unit, such as a virtual central unit (VCU), a virtual distributed unit (VDU), or a virtual radio unit (VRU), among other examples.

Disaggregated network nodes 110 in the wireless network 100 may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. In some examples, a network node 110 may be or include a network node that communicates with other network nodes 110 via a fronthaul link or a midhaul link, such as a DU. For example, a DU may facilitate communication between an RU and a CU. In some examples, a network node 110 may be or include a network node that communicates with other network nodes 110 via a midhaul link or a core network via a backhaul link, such as a CU.

A network node 110 that relays communications may be referred to as a relay station, a relay network node, or a relay. A relay station may receive a transmission of data from an upstream station (for example, a network node 110 or a UE 120) and send a transmission of the data to a downstream station (for example, a UE 120 or a network node 110). In the example shown in FIG. 1, the network node 110d (for example, a relay network node) may communicate with the network node 110a (for example, a macro network node) and the UE 120d in order to facilitate communication between the network node 110a and the UE 120d. Additionally and/or alternatively, a UE 120 may be or may operate as a relay station that can relay transmissions for other UEs 120. A UE 120 that relays communications may be referred to as a UE relay or a relay UE, among other examples.

In some examples, a network node 110 may be or include a network node, such as an RU, a TRP, or a base station, that communicates with UEs 120 via a radio access link (which may be referred to as a “Uu” link). The radio access link may include a downlink and an uplink. “Downlink” (or “DL”) refers to a communication link from a network node 110 to a UE 120, and “uplink” (or “UL”) refers to a communication link from a UE 120 to a network node 110. The downlink may include one or more control channels on which control information (for example, scheduling information, reference signals, configuration information) may be transmitted and received, and one or more data channels on which data (for example, data associated with a UE 120) may be transmitted and received. The one or more control channels may include one or more physical downlink control channels (PDCCHs), and the one or more data channels may include one or more physical downlink shared channels (PDSCHs). The uplink may include one or more control channels on which control information (for example, feedback for one or more downlink transmissions, reference signals) may be transmitted and received, and one or more data channels on which data (for example, data associated with a UE 120) may be transmitted and received. The one or more control channels may include one or more physical uplink control channels (PUCCHs), and the one or more data channels may include one or more physical uplink shared channels (PUSCHs). The downlink and the uplink may each include a set of resources on which the network node 110 and the UE 120 may communicate.

The resources for the downlink and for the uplink may each include one or more time domain resources (frames, subframes, slots, symbols), frequency domain resources (frequency bands, frequency carriers, subcarriers, resource blocks, resource elements), spatial domain resources (particular transmit directions or beam parameters), or a combination thereof. The frequency domain resources for the downlink and/or for the uplink may be divided into one or more bandwidth parts (BWPs). A bandwidth part may refer to a continuous block of frequency domain resources that are allocated for one or more UEs 120. A bandwidth part may be dynamically configured (for example, by a network node 110 transmitting a dynamic control information (DCI) configuration to the one or more UEs 120) and/or reconfigured, which means that a bandwidth part can be adjusted in real-time (or near-real-time) based on changing network conditions in the wireless network 100 and/or based on the specific requirements of the one or more UEs 120. This allows for more efficient use of the available frequency domain resources in the wireless network 100.

Some network nodes 110 (for example, a base station, an RU, a TRP) may provide communication coverage for a particular geographic area. In the Third Generation Partnership Project (3GPP), the term “cell” can refer to a coverage area of a network node 110 or a network node subsystem serving this coverage area, depending on the context in which the term is used. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, relay network nodes, aggregated network nodes, and/or disaggregated network nodes, among other examples. Some types of network nodes 110 may have different transmit power levels, different coverage areas, and/or different impacts on interference in the wireless network 100 than other types of network nodes. For example, macro network nodes may have a high transmit power level (for example, 5 to 40 watts), whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node such as a train, a satellite base station, a drone, or a non-terrestrial network (NTN) network node).

A network controller 130 may couple to or communicate with a set of network nodes 110 and may provide coordination and control for these network nodes 110. In some aspects, the wireless network 100 includes one or more network controllers 130. Additionally and/or alternatively, a core network associated with the wireless network 100 may include one or more network controllers 130. A network controller 130 may communicate with a network node 110 via a backhaul communication link. The backhaul link may facilitate communication between the wireless network 100 and the core network. In some aspects, the network controller 130 may be, include, or be included in a CU or a core network device.

The UEs 120 may be dispersed throughout the wireless network 100, and each UE 120 may be stationary or mobile. A UE 120 may be, include, or be included in, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter or sensor, industrial manufacturing equipment, a Global Positioning System device (or other position device), a UE function of a network node, or any other suitable device or function that may communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment.

A UE 120 may include, or may be included in, a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some aspects, two or more UEs 120 (for example, shown as UE 120a and UE 120e) may communicate directly using one or more sidelink channels (for example, without communicating through a network node 110 as an intermediary to communicate with one another). As an example, the UE 120a may transmit a sidelink communication to the UE 120e directly on a sidelink instead of transmitting the sidelink communication to a network node 110 on an uplink for the network node 110 to then transmit the sidelink communication to the UE 120e on a downlink. The UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, a vehicle-to-pedestrian (V2P) protocol), and/or a mesh network. In some examples, a network node 110 may still schedule and/or allocate resources for sidelink communication between UEs 120 in the wireless network 100. Alternatively, a UE 120 may perform scheduling operations, resource selection operations, and/or other operations described elsewhere herein for sidelink communication instead of a network node 110.

Devices (for example, UEs 120, network nodes 110) of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular radio access technology (RAT) and may operate on one or multiple carrier frequencies in one or multiple frequency ranges such as 410 MHz-7.125 GHz or 24.25 GHz-52.6 GHZ, among other examples. A RAT may also be referred to as an air interface and may include a 4G RAT, a 5G/NR RAT, and/or a 6G RAT, among other examples. In some examples, when multiple RATs are deployed in a given geographic area, each RAT in the geographic area may operate on different frequencies in order to avoid interference between wireless networks of different RATs.

In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may be referred to as frequency range designation FR3 (7.125 GHZ-24.25 GHz). Frequency bands falling within FR3 may inherit FR1 characteristics or FR2 characteristics, and thus may effectively extend features of FR1 or FR2 into mid-band frequencies. In addition, higher frequency bands may extend 5G NR operation, 6G operation, and/or other RATs beyond 52.6 GHz. For example, three higher operating bands may be referred to as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a CSI-RS in each of a plurality of CSI-RS occasions; and transmit, to a network node 110, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report. Additionally or alternatively, the communication manager 140 may perform one or more other operations described herein.

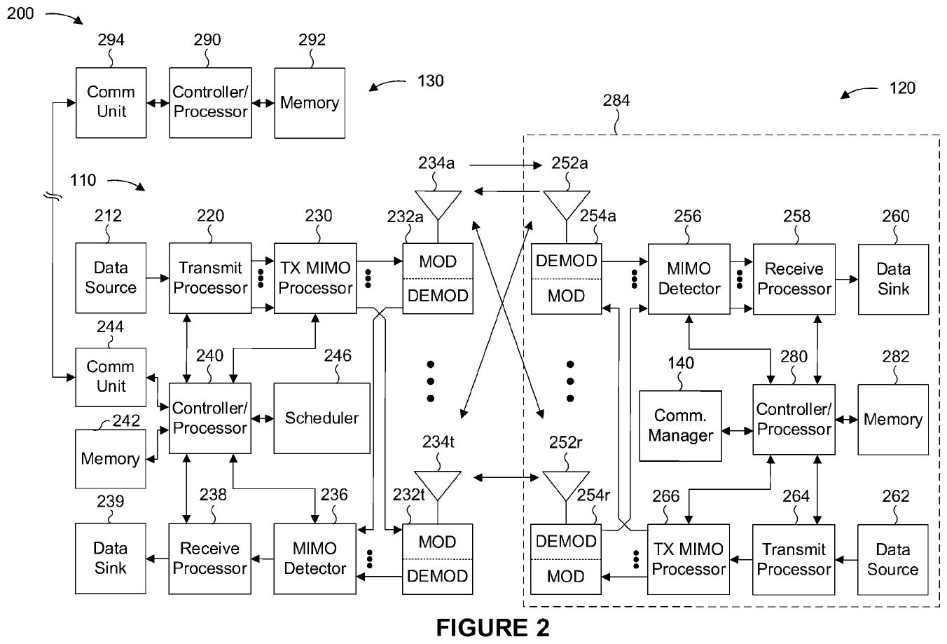

FIG. 2 is a diagram illustrating an example 200 of a network node in communication with a UE in a wireless network in accordance with the present disclosure. The network node may correspond to the network node 110 of FIG. 1. Similarly, the UE may correspond to the UE 120 of FIG. 1.

As shown in FIG. 2, the network node 110 may include a data source 212, a transmit processor 220, a transmit (TX) multiple-input multiple-output (MIMO) processor 230, a set of modems 232 (such as 232a through 232t, where t≥1), a set of antennas 234 (such as 234a through 234t, where t≥1), a MIMO detector 236, a receive processor 238, a data sink 238, a controller/processor 240, a memory 242, a communication unit 244, and/or a scheduler 246, among other examples. In some aspects, one or a combination of the antenna(s) 234, the modem(s) 232, the MIMO detector 236, the receive processor 238, the transmit processor 220, or the TX MIMO processor 230 may be included in a transceiver that is included in the network node 110. The transceiver may be used by a processor (for example, the controller/processor 240) and the memory 242 to perform aspects of any of the methods described herein. In some aspects, a network node 110 may include another interface, another communication component, and/or another component (such as a network interface) that facilitates communication with the UE 120 or another network node. Some network nodes 110 (such as one or more CUs or one or more DUs) may not include radio frequency components that facilitate direct communication with the UE 120.

For communication on a downlink, the transmit processor 220 may receive data, from the data source 212. The data may be intended for the UE 120 (or a set of UEs 120), and may thus be referred to as downlink data. In some implementations, the transmit processor 220 may select one or more modulation and coding schemes (MCSs) for the UE 120 in accordance with one or more channel quality indicators (CQIs) received from the UE 120. The network node 110 may process the data (for example, may encode the data) for transmission to the UE 120 on a downlink in accordance with the MCS(s) selected for the UE 120 to generate data symbols, and may provide the data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS), a demodulation reference signal (DMRS), or a channel state information (CSI) reference signal) and synchronization signals (for example, a primary synchronization signal (PSS) or a secondary synchronization signals (SSS)).

The TX MIMO processor 230 may perform spatial processing (for example, precoding) on the data symbols, the control symbols, the overhead symbols, or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, or upconvert) the output sample stream to obtain a downlink signal.

The modems 232a through 232t may transmit a set of downlink signals (for example, T downlink signals) via the corresponding set of antennas 234. A downlink signal may include a DCI communication, a medium access control (MAC) control element (MAC-CE) communication, an RRC communication, or another type of downlink communication. A downlink signal may carry one or more transport blocks of data. A transport block may refer to a unit of data that is transmitted over an air interface in the wireless network 100. A data stream may be encoded into a plurality of transport blocks for transmission over the air interface. The quantity of transport blocks for a particular data stream may be associated with a transport block size. The transport block size may be based on or otherwise associated with radio channel conditions on the air interface, the MCS used for encoding the data, the downlink resources allocated for transmitting the data, and/or another parameter. In general, the larger the transport block size, the greater the amount of data that can be transmitted in a single transmission, which reduces signaling overhead. However, larger transport block sizes may be more prone to transmission and/or reception errors, which may be mitigated by more robust error correction techniques.

One or more antennas of the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2.

Each of the antenna elements of an antenna 234 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (for example, to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (for example, angle of arrival, horizontal direction, vertical direction), and/or a set of parameters that indicate one or more aspects of a directional signal, a direction associated with a signal, and/or a set of directional resources associated with a signal. Antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between the UE 120 and the network node 110, such as for millimeter wave communications. In such a case, the network node 110 may provide the UE 120 with a configuration of transmission configuration indicator (TCI) states that respectively indicate beams that may be used by the UE 120, such as for receiving a PDSCH. The network node 110 may indicate an activated TCI state to the UE 120, which the UE 120 may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, and/or qcl-TypeD), a cell identification (for example, a ServCellIndex), a bandwidth part identification (bwp-Id), and/or a reference signal identification such as a CSI-RS (for example, an NZP-CSI-RS-ResourceId, and/or an SSB-Index). Spatial relation information may similarly indicate information associated with an uplink beam.

The beam indication may be a joint or separate downlink/uplink beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network node 110 may include a support mechanism for the UE 120 to acknowledge successful decoding of a beam indication. For example, the acknowledgment/negative acknowledgment of the PDSCH scheduled by the DCI carrying the beam indication may be also used as an ACK for the DCI.

Beam indications may be provided for carrier aggregation scenarios. In a unified TCI framework, information the network may support common TCI state ID update and activation to provide common QCL and/or common UL transmission spatial filter or filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

For communication on an uplink, uplink signals from a UE 120 or other UEs may be received on an uplink by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and control information sent by the UE 120. The receive processor 238 may provide the decoded data to a data sink 239 and provide the decoded control information to the controller/processor 240. The term “controller/processor” may refer to one or more controllers and/or one or more processors.

The network node 110 may use the communication unit 244 to communicate with a network controller 130. The communication unit 244 may support wired and/or wireless communication protocols and/or connections such as Ethernet, optical fiber, and/or common public radio interface (CPRI), among other examples. The network node 110 may use the communication unit 244 to communicate with a network controller 130 to transmit and/or receive data associated with the UE 120 or to perform network control signaling, among other examples.

The network node 110 may use the scheduler 246 to schedule one or more UEs 120 for downlink or uplink communications. In some aspects, the scheduler 246 may use DCI to dynamically schedule transmissions to the UE 120 and/or transmissions from the UE 120. In some aspects, the scheduler 246 may use an RRC configuration (for example, a semi-static configuration) to perform semi-persistent scheduling (SPS) or configured grant (CG) configuration for a UE 120, where the scheduler 246 may allocate a recurring time domain resources and/or frequency domain resources that the UE 120 may use to transmit and/or receive communications in the wireless network 100.

One or more of the transmit processor 220, the TX MIMO processor 230, the modem 232, the antenna 234, the MIMO detector 236, the receive processor 238, and/or the controller/processor 240 may be included in an RF chain of the network node 110. An RF chain may include filters, mixers, oscillators, amplifiers, analog-to-digital converters (ADCs), and/or other devices that convert between an analog signal (such as for transmission or reception on an air interface) and a digital signal (such as for processing by one or more processors of the network node 110).

The UE 120 may include a set of antennas 252 (shown as antennas 252a through 252r, where r≥1), a set of modems 254 (shown as modems 254a through 254r, where r≥1), a MIMO detector, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be used by a processor (for example, the controller/processor 280) and the memory 282 to perform aspects of any of the methods described herein. In some aspects, the UE 120 may include another interface, another communication component, and/or another component that facilitates communication with the network node 110 and/or another UE 120.

One or more antennas of the set of antennas 252 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. In some examples, each of the antenna elements of an antenna 234 may include one or more sub-elements for radiating or receiving radio frequency signals.

For communication on the downlink, the set of antennas 252 may receive the downlink signals from the network node 110 or other network nodes 110 and may provide a set of received signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to a data sink 260, and may provide decoded control information and system information to a controller/processor 280.

For communication on the uplink, the transmit processor 264 may receive and process data from a data source 262 and control information from the controller/processor 280. The data may include data that is to be transmitted to the network node 110 and/or to another UE. The control information may include one or more parameters, feedback, one or more signal measurements, and/or other types of control information. In some aspects, the receive processor 258 and/or the controller/processor 280 may determine one or more parameters for a received signal (such as received from the network node 110 or another UE), such as a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266 if applicable, further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, or upconvert) the output sample stream to obtain an uplink signal.

The modems 254a through 254r may transmit a set of uplink signals (for example, R downlink signals) via the corresponding set of antennas 252. An uplink signal may include an uplink control information (UCI) communication, a MAC-CE communication, an RRC communication, or another type of uplink communication. An uplink signal may carry one or more transport blocks of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

The network controller 130 may include a communication unit 294, a controller/processor 290, and a memory 292. The network controller 130 may include, for example, one or more devices in a core network. The network controller 130 may communicate with the network node 110 on a backhaul link via the communication unit 294. The network controller 130 may provide the UE 120 with access to (via the network node 110 and the core network) a local area network (LAN), a wide area network (WAN) such as the Internet, a storage area network, a local data network, a private network, a content delivery network (CDN), and/or another network that is communicatively connected with the core network. In some aspects, the network controller 130 may facilitate access by the UE 120 to one or more services hosted in the core network, such as content delivery services, gaming services, storage services, streaming services, and/or another type of services.

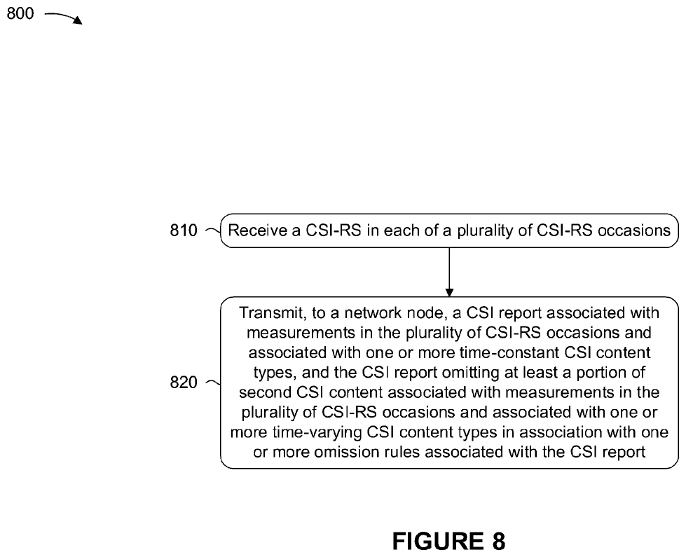

The controller/processor 240 of the network node 110, the controller/processor 280 of the UE 120, or any other component(s) of FIG. 2 may implement one or more techniques or perform one or more operations associated with a time-constant and time-varying split for Doppler CSI, as described in more detail elsewhere herein. For example, the controller/processor 240 of the network node 110, the controller/processor 280 of the UE 120, or any other component(s) of FIG. 2 may perform or direct operations of, for example, process 800 of FIG. 8 or other processes as described herein. The memory 242 and the memory 282 may store data and program codes for the network node 110 and the UE 120, respectively. In some examples, the memory 242 or the memory 282 may include a non-transitory computer-readable medium storing a set of instructions (for example, code or program code) for wireless communication. For example, the set of instructions, when executed (for example, directly, or after compiling, converting, or interpreting) by one or more processors of the network node 110 or the UE 120, may cause the one or more processors to perform process 800 of FIG. 8 or other processes as described herein. In some examples, executing instructions may include running the instructions, converting the instructions, compiling the instructions, or interpreting the instructions, among other examples.

In some aspects, the UE 120 includes means for receiving a CSI-RS in each of a plurality of CSI-RS occasions; and/or means for transmitting, to a network node 110, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

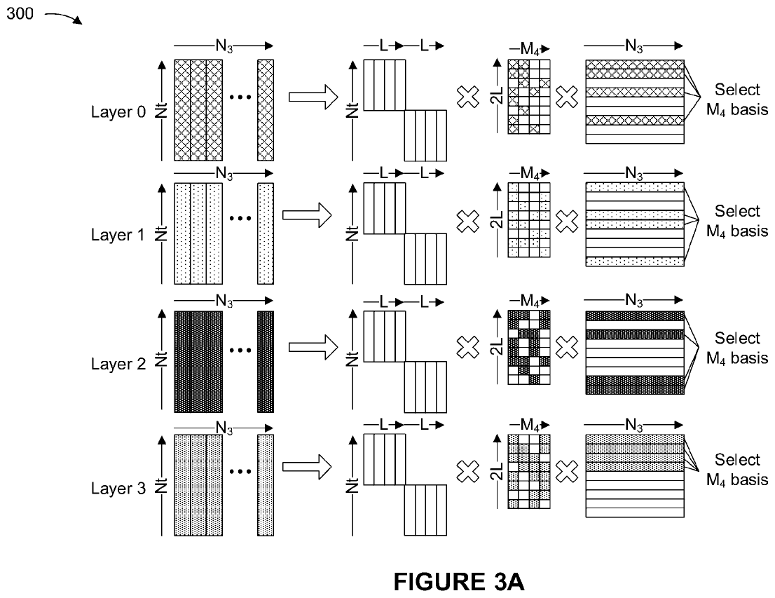

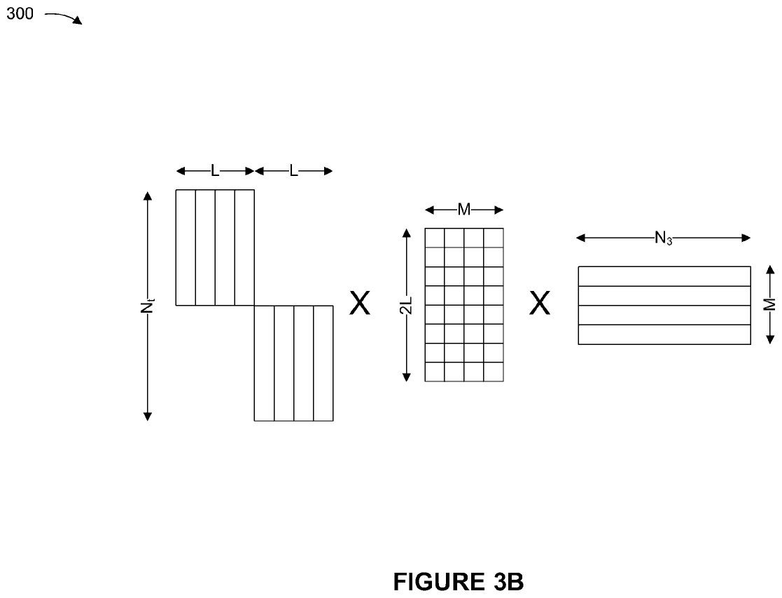

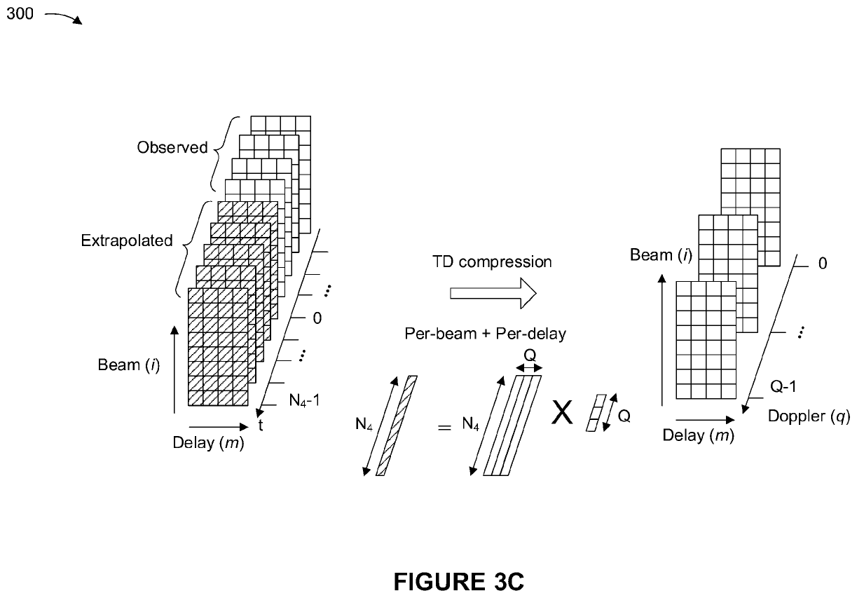

FIGS. 3A-3C are diagrams illustrating examples 300 of codebook structures that may be used to report Doppler CSI in accordance with the present disclosure. In particular, FIG. 3A illustrates an example precoder for enhanced Type II (eType-II) CSI with support for up to a rank of 4. Each layer (for example, layers 0 to 3, as shown in FIG. 3A) corresponds to a different data stream. For each layer, the precoder across a number of N₃ precoder matrix indicator (PMI) subbands is an Nₜ×N₃ matrix W, such that a precoder

$$W = {W}_{1} \times {\tilde{W}}_{2} \times {W}_{f}^{H} .$$

It this case, W₁ is layer-common, represents discrete Fourier transform (DFT) bases, and is an Nₜ×2L matrix of spatial domain (SD) bases (which may also be referred as “SD beams”), where Nₜ is configured by radio resource control (RRC) signaling and Nₜ=2N₁O₁N₂O₂, representing a quantity of transmit antennas with O₁ and O₂ oversampling. Furthermore, L may be configured by RRC signaling, and may have a value of 2, 4, or 6. Further,

$${W}_{f}^{H}$$

is layer-specific, represents DFT bases, and is an M×N₃ matrix of frequency domain bases, where M represents a quantity of frequency domain bases and is rank-pair specific, such that M₁=M₂ for a rank of 1 or 2 and M₃=M₄ for a rank of 3 or 4, and M₁ or M₃ is RRC-configured. Further, \tilde{W}₂ is layer-specific and forms a 2L×M coefficients matrix, with up to K₀ non-zero coefficients (NZCs) for each layer (and where K₀ is an RRC-configured parameter). Across all layers, a UE may report up to 2K₀ NZCs, with unreported coefficients being set to zeroes. Furthermore, in some cases, one or more of the coefficients in \tilde{W}₂ may be quantized. In general, after the UE transmits a CSI report to indicate the precoder W to a network node, the network node assumes that the precoder W is constant over a certain time period, and uses the precoder for precoding one or more PDSCH transmissions until a next CSI report is provided.

FIG. 3B shows another example of an eType-II CSI precoding matrix for a layer, where

$$W = {W}_{1} \times {\tilde{W}}_{2} \times {W}_{f}^{H} ,$$

where W₁ represents selected spatial domain bases,

$${W}_{f}^{H}$$

represents selected frequency domain bases, and \tilde{W}₂ represents a coefficient matrix, as described in more detail above. One challenge associated with Type-II CSI feedback as described herein is a relatively large feedback overhead for reporting the coefficients on a subband basis. The feedback overhead may increase (for example, approximately linearly) with the quantity of subbands. As a result, an overhead associated with CSI report may become large for large quantities of subbands. Therefore, an eType-II codebook has been defined (for example, by the 3GPP) to overcome the large feedback overhead associated with previous Type-II CSI feedback.

As shown in FIG. 3B, the eType-II precoding matrix may be a three-stage precoder that relies on a three-stage codebook (for example, three components),

$${W}_{1} {W}_{2}^{r} {W}_{f}^{r} .$$

The matrix W₁, may be similar to the matrix W₁ described above and may be independent of the layer (r). The matrix W₁ may contain a quantity of SD basis vectors selected from a spatial codebook. The matrix

$${W}_{f}^{r}$$

may be layer-dependent and may be used to select a quantity of frequency domain (or delay domain) basis vectors from a DFT-based matrix (which may be referred to as a delay codebook). The matrix

$${W}_{2}^{r}$$

may be layer-dependent and may contain a quantity of combining coefficients that are used to combine the selected SD basis vectors and frequency domain basis vectors from the spatial and delay codebooks, respectively. As shown in FIG. 3B, the matrix W₁ may contain Nₜ rows, where Nₜ is a quantity of spatial domain basis candidates or antenna ports, and 2L columns, where Z is a quantity of selected CSI-RS ports per polarization (for example, a quantity of selected CSI-RS ports for a given transmission layer). The matrix W_{f} may have N₃ columns and M rows, where N₃ is a quantity of configured orthogonal DFT basis vectors or frequency domain candidates and M is a quantity of selected frequency domain basis vectors. A value of N₃ may depend on a quantity of CQI subbands and a quantity of PMI subbands, which may be RRC configured values. A value of M may be based on RRC configured parameters, such as RRC CSI codebook parameter Pᵥ. For example, a value of M may be

$${P}_{v} \times \frac{{N}_{3}}{R} ,$$

where R is a PMI subband size indicator (for example, which may be RRC configured). The matrix W₂ may have 2L rows and M columns, where M is a quantity of selected frequency domain basis vectors.

The matrix W₂ may be a linear combination coefficient matrix that includes 2L·M coefficients for linearly combining the selected M frequency domain basis vectors for the selected 2L CSI-RS ports. A UE may report (for example, in the CSI report) NZCs from the matrix W₂. For example, for a layer l, only a subset of

$${K}_{l}^{NZ}$$

coefficients are non-zero and reported. The remaining

$$( 2 L \cdot M ) - {K}_{l}^{NZ}$$

coefficients are not reported by the UE (for example, in the CSI report) and are considered zero. In some examples,

$${K}_{l}^{NZ} \leq {K}_{0} ,$$

where K₀ is a maximum quantity of NZCs for each layer, represented by K₀=[β×2LM], where β is an RRC configured parameter. The selected NZCS

$${K}_{l}^{NZ}$$

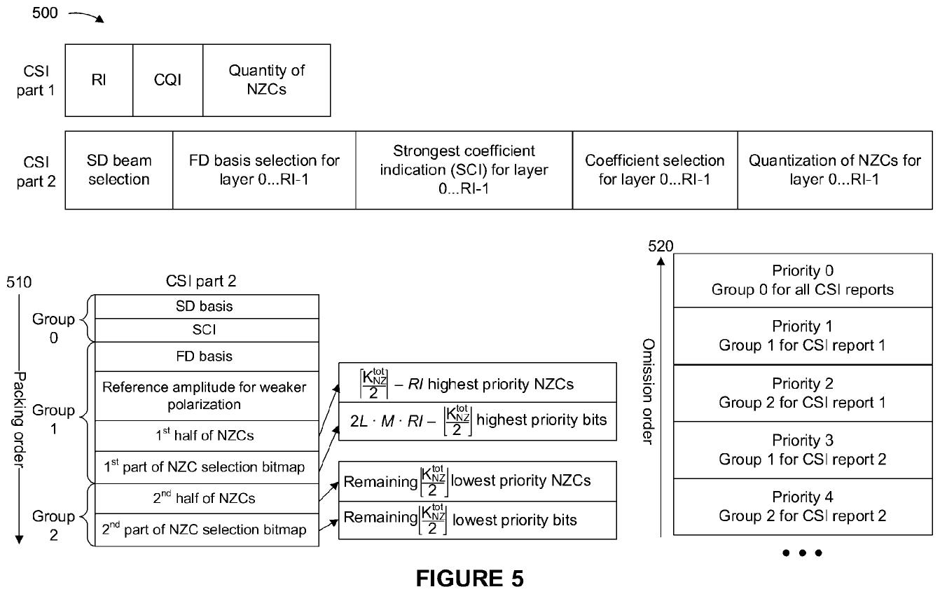

for each layer, l, may be indicated via a bitmap (for example, having a size 2LM). For example, a value of “1” in the bitmap may indicate that a coefficient corresponding to the bit is non-zero, selected and reported by the UE. A value of “0” in the bitmap may indicate that the coefficient corresponding to the bit is zero, and hence not reported by the UE. The bitmap may be included in the CSI report. For example, the bitmap may be included in a part 2 of the CSI report, which may also be referred to as UCI or CSI part 2 (for example, as depicted and described in more detail in connection with FIG. 5).

A configuration (for example, an RRC configuration) associated with the CSI report may indicate a parameter indicating a quantity of spatial domain basis vectors to be selected by the UE from the spatial codebook for the calculation of W₁, a parameter indicating a quantity of frequency domain (or delay domain) basis vectors to be selected by the UE per layer from the delay codebook for the calculation of W_{f}, a value of K₀, or a value of N₃, among other examples. The UE may transmit a CSI report including a rank indication (RI) (for example, indicating a quantity of selected layers of the precoding matrix), a CQI, and a quantity of the NZCs selected by the UE. Additionally, the CSI report may include an indication of a PMI. The PMI may include indications of a spatial domain subset indicator (SD basis indicator) indicating the selected spatial domain basis vectors (i_{1,1}, i_{1,2}) (for example, the selected beams) for the RI layers of the precoding matrix, a frequency domain subset indicator indicating, for each layer (0 to RI−1), the selected frequency domain basis vectors (i_{1,5} and i_{1,6,l}), a strongest coefficient indicator (SCI) for each layer (0 to RI−1) indicating the SD basis index (or the SD and frequency domain basis indices) associated with the strongest coefficient (which is not reported) (i_{1,8,l}), a bitmap per layer indicating the SD basis indices and frequency domain basis indices associated with the NZCs for each layer (i_{1,7,l}), or a quantization of the selected NZCs (i_{2,3,l}, i_{2,4,l}, i_{2,5,l}), among other examples. For example, one or more frequency domain vectors may be identified and indicated by the indices i_{1,5} (for N₃>19) and i_{1,6,l}. Amplitude coefficient indicators may be i_{2,3,l} and i_{2,4,l}. A phase coefficient indicator may be i_{2,5,l}. A bitmap whose nonzero bits identify which coefficients in i_{2,4,l} and i_{2,5,l} are reported may be indicated by i_{1,7,l}.

FIG. 3C shows an example of a time-domain codebook that can be used to represent a fast-varying (for example, over a time instance n) precoding matrix

$$W ( n ) = {W}_{1} \times {\tilde{W}}_{2} ( n ) \times {W}_{f}^{H} .$$

For example, in a medium or high velocity channel (for example, when a UE and/or a network node is moving at a medium or high velocity), there may be rapid variation in the precoder or CSI associated with the channel, and the time-domain codebook may be used to represent the time-dependent channel variation in the CSI report that the UE provides to the network node. Accordingly, in contrast to legacy CSI reporting techniques (for example, as shown in FIGS. 3A-3B), where a UE reports one precoder that is assumed to be generally constant over a duration until a next CSI report is provided, the time-domain codebook and CSI reporting techniques shown in FIG. 3C can be used to extrapolate CSI in a time domain to obtain future precoders for a fast-varying channel that may otherwise need more frequent CSI reports. Furthermore, one or more time domain compression techniques may be applied to the future precoders to reduce an overhead associated with the CSI report that indicates the future precoders.

For example, as shown in FIG. 3C and described herein, a coefficient matrix \tilde{W}₂(n) for n=0 . . . N₄−1 is compressible into a Doppler domain, which may interchangeably be referred to as a time domain. Further, the spatial domain and frequency domain bases W₁ and

$${W}_{f}^{H}$$

are constant over the time instance n. Notably, compressing the coefficient matrix \tilde{W}₂(n) into the Doppler domain (or time domain) reduces reporting overhead. CSI generated using a time domain codebook can be referred to as type-II Doppler CSI or time domain CSI. Accordingly, to construct the precoding matrix, a UE may report one or more CSI-RS observations (with N_{ob}=N₄, where N_{ob} represents a quantity of observations) with compression at the UE and prediction at a network node. Additionally or alternatively, the UE may report the one or more CSI-RS observations and a set of extrapolations based on the one or more CSI-RS observations, such that both compression and prediction occur at the UE.

For example, the UE may measure a CSI-RS over a burst of CSI-RS occasions (for example, a plurality of CSI-RS occasions within a threshold time period), and the UE may extrapolate the measurements to predict or otherwise obtain future precoders W(n) for n=0, . . . , N₄−1. In this case, spatial domain and frequency domain bases W₁, W_{f} are assumed to be constant over time, and the extrapolated coefficient matrix \tilde{W}₂(n), n=0, . . . , N₄−1 is compressed into a Doppler domain to reduce an overhead of the type-II Doppler CSI reported by the UE. For example, as shown in FIG. 3C, the UE may measure a CSI-RS in a plurality of CSI-RS burst occasions to obtain a time-series of observations (for example, CSI-RS measurements), which are then extrapolated for a future time from time n=0 until N₄ to obtain a set of future precoders, which are then compressed from a time domain t into a Doppler domain q. For example, in FIG. 3C, the future precoders include five slices (shown with a shaded fill pattern), which is compressed according to Q time domain or Doppler bases (for example, Q has a value of three in FIG. 3C, which results in a compression where the five future precoders are represented as three precoders in a Doppler domain, corresponding to indexes 0, Q−2, and Q−1, thereby reducing an overhead associated with reporting the (extrapolated) future precoders.

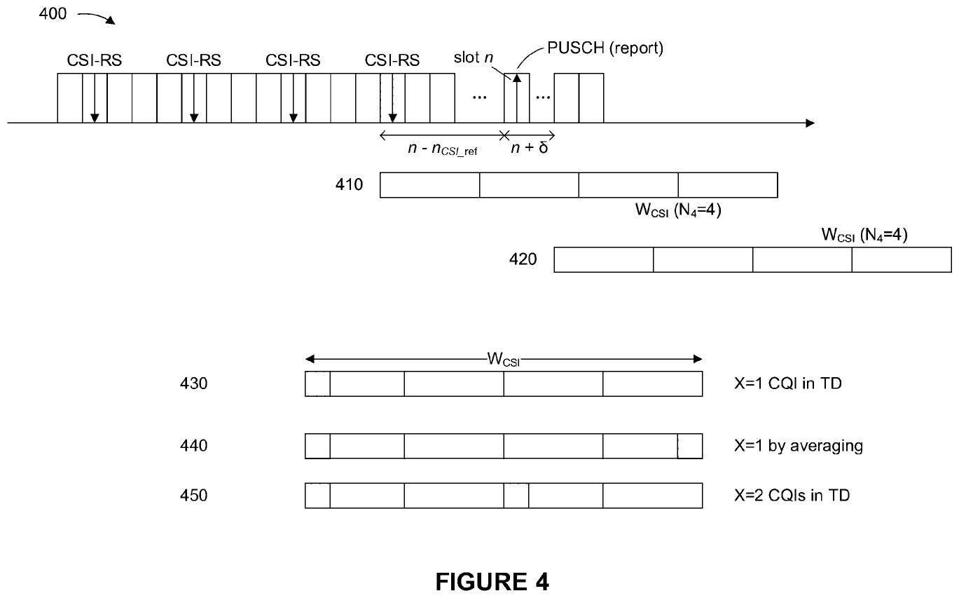

FIG. 4 is a diagram illustrating an example 400 of a CSI window in a time domain in accordance with the present disclosure. In some aspects, as described herein, the CSI window may generally refer to a future time window, or a future time duration, associated with extrapolated or predicted CSI feedback that the UE reports to a network node. For example, in cases where the UE uses a time-domain codebook to extrapolate, predict, or otherwise obtain one or more future precoders W(n) based on CSI measurements or observations performed in a burst of CSI-RS occasions, CSI feedback that the UE reports to a network node for the one or more future precoders W(n) (for example, after compression to a Doppler domain) may be associated with a CSI window (W_{CSI}).

In some aspects, the CSI window may include a starting slot, l, which may have a value that depends on a configuration (for example, provided by the network node and/or a wireless communication standard), and a window size equal to dN₄ slots. For example, in a first configuration 410, the starting slot of the CSI window may correspond to a legacy reference resource (for example, four or five slots prior to a slot n in which the UE transmits the CSI report that carries the extrapolated or predicted CSI feedback). In another example, in a second configuration 420, the starting slot of the CSI window may correspond to the slot n in which the UE transmits the CSI report that carries the extrapolated or predicted CSI feedback plus a delta, δ, which may have a value of 0, 1, or 2 slots (for example, in association with a delay associated with the network node applying the PMI reported in the CSI feedback). Furthermore, for the window size, N₄ is a unitless value that corresponds to a time domain basis length (for example, a quantity of future precoders W(n) represented in the compressed CSI feedback), and d is a quantity of slots that corresponds to a time granularity of the PMI reported in the CSI feedback (for example, a quantity of slots associated with each of the future precoders W(n) represented in the compressed CSI feedback). For example, in FIG. 4, the window size in the first configuration 410 and the second configuration 420 is 4 slots, based on a time domain length of N₄=4 and the PMI having a time granularity of 1 slot.

In some aspects, when the UE transmits a PUSCH message carrying the CSI report that indicates the extrapolated or predicted CSI feedback associated with the CSI window, the UE may indicate X CQIs in the time domain for one or more slots within the CSI window. For example, in a first configuration 430, the UE may report one CQI (X=1) in the time domain, in which case the extrapolated or predicted CSI feedback may include a CQI value only for a starting slot in the CSI window. Additionally or alternatively, in a second configuration 440, the UE may report one CQI (X=1) in the time domain by averaging the CQIs of the starting slot l of the CSI window and the ending slot, l+W_{SCI}−1 for the CSI window. Additionally or alternatively, in a third configuration 450, the UE may report two CQIs (X=2) in the time domain, where the two CQIs may correspond to the starting slot/of the CSI window and the middle slot of the CSI window, l+W_{SCI}/2 for the CSI window.

FIG. 5 is a diagram illustrating an example 500 of CSI packing and prioritization, in accordance with the present disclosure. As shown in FIG. 5, a CSI report or UCI may include two parts, referred to as CSI part 1 and CSI part 2. “CSI part 1” and “UCI part 1” may be used interchangeably herein. Similarly, “CSI part 2” and “UCI part 2” may be used interchangeably herein. Content included in the CSI part 1 and the CSI part 2 may be defined, or otherwise fixed, in a wireless communication standard (for example, 3GPP Technical Specification 38.214, Section 5.2.3 may define content included in CSI part 1 and CSI part 2 and prioritization of the content).

As shown in FIG. 5, the CSI part 1 may include an indication of an RI, a CQI, and a quantity of NZCs (or number of non-zero coefficients (NNZC)) associated with the PMI. The CSI part 2 may include the selected SD basis vectors (i_{1,1}, i_{1,2}) (for example, the selected beams) for the RI layers of the precoding matrix, a frequency domain subset indicator indicating, for each layer (0 to RI−1), the selected frequency domain basis vectors (ins and i_{1,6,l}), an SCI for each layer (0 to RI−1) indicating the SD basis index (or the SD and frequency domain basis indices) associated with the strongest coefficient (i_{1,8,l}), a bitmap for the coefficient selections for each layer indicating the SD basis indices and frequency domain basis indices associated with the non-zero coefficients for each layer (i_{1,7,l}), and/or a quantization of the selected non-zero coefficients (i_{2,3,l}, i_{2,4,l}, i_{2,5,l}), among other examples. The CSI part two is not necessarily packed in the order shown in FIG. 5. The CSI part 1 generally has a higher priority than the CSI part 2. For example, when determining the content to be included in a CSI report, the content included in the CSI part 1 has a higher priority than the content included in the CSI part 2. Furthermore, because the CSI part 1 has a higher priority than the CSI part 2, the CSI part 1 has a smaller and fixed payload size and is transmitted with a higher reliability than the CSI part 2, which has a variable payload size that depends on the content of the CSI part 1. For example, because the frequency domain basis selection, the SCI, the coefficient selection, and the quantized NZCs may be provided for layer zero (0) through layer RI−1, the RI (or quantity of layers) indicated in the CSI part 1 and/or the NNZC value indicated in the CSI part one 1 may determine the payload size of the CSI part 2. The frequency domain basis selection may include one or more parameters that indicate a selection of M frequency domain bases out of a configured quantity of frequency domain bases for W_{f} per layer, the SCI may indicate the locations of the strongest coefficient in \tilde{W}₂ per layer, the coefficient selection may indicate the location of NZCs within \tilde{W}₂ per layer, and the quantized NZCs may indicate amplitude and/or phase quantization for NZCs (for example, a differential quantization based on the SCI).

In some cases, when reporting CSI feedback, a UE may apply CSI packing and/or CSI omissions rules for a PUSCH-based resource allocation. For example, a UE may drop or omit some parts of one or more CSI reports in scenarios where an uplink resource allocation (for example, a PUSCH resource allocation) is insufficient to carry the entire content of the one or more CSI reports. CSI omission may occur when a network node did not accurately allocate the PUSCH resources when scheduling the CSI report(s). For example, the network node may allocate resources for a rank-1 (RI=1) CSI report, but the UE may determine a rank-2 transmission and report a rank-2 (RI=2) CSI report having a size that exceeds the size of the allocated PUSCH resources. In other words, the network (for example, one or more network nodes) may not know the RI value that will be selected by the UE when the network allocates the uplink resources for the CSI report(s), which may result in the allocated uplink resources being insufficient (for example, not large enough) to carry the entire content of the CSI report(s). Additionally or alternatively, the allocated uplink resources may be insufficient to carry the entire content of the CSI report(s) in cases where the network node is attempting to reduce overhead associated with the CSI report(s).

In such examples, the UE may drop a portion of the CSI content (for example, which may be referred to as CSI omission or CSI packing with omission rules). Dropping a portion of the CSI content from one or more CSI reports may be achieved by decomposing the CSI payload associated with the CSI reports into groups that are associated with different priority levels. Each priority level is associated with a group of information, or certain content, associated with a CSI report. Similarly, content associated with a CSI report may be associated with a group, which may define the priority level of the corresponding content. In general, as described herein, the UE may drop content included in the CSI groups with lower priorities until the payload size of the CSI reports fits with the uplink resource allocation (for example, the PUSCH resource allocation) for the CSI report(s). The size of CSI part 1 may be fixed, whereas a size of the CSI part 2 may vary depending on the selected RI by the UE and/or other factors. Because the network node may need information indicated by the CSI part 1 in order to decode the CSI part 2, CSI omission and/or prioritized CSI packing may be performed on the CSI part 2 (for example, and not the CSI part 1). In other words, information associated with the CSI part 1 is not dropped by the UE.

As shown in FIG. 5, the content associated with the CSI part 2 may be divided into different groups. For example, a first group with a highest priority (for example, referred to as group 0) may include the selected spatial domain basis vectors (i_{1,1}, i_{1,2}) (for example, the selected beams) for the RI layers of the precoding matrix and the SCI for each layer (0 to RI−1) indicating the SD basis index (or the SD and frequency domain basis indices) associated with the strongest coefficient (i_{1,8,l}). As further shown, a second group with an intermediate priority (for example, referred to as group 1) may include the selected frequency domain basis vectors (i_{1,5}, i_{1,6,l}), a reference amplitude for a weakest polarization associated with the selected NZCs (i_{2,3,l}), a quantization of a first half of the selected NZCs (i_{2,4,l}, i_{2,5,l}) (for example,

$$⌈ \frac{{K}_{NZ}^{tot}}{2} ⌉ - RI$$

highest priority NZCs), and a bitmap indicating the spatial domain and frequency domain indices associated with the first half of the selected NZCs (i_{1,7,l}) (for example,

$$2 L \cdot M \cdot RI - ⌊ \frac{{K}_{NZ}^{tot}}{2} ⌋$$

highest priority bits). As further shown, a third group with a lowest priority (for example, referred to as group 2) may include a quantization of a second half of the selected NZCs (i_{2,4,l}, i_{2,5,l}) (for example, a remaining

$$⌊ \frac{{K}_{NZ}^{tot}}{2} ⌋$$

lowest priority NZCs) and a bitmap indicating the spatial domain and frequency domain indices associated with the second half of the selected NZCs (i_{1,7,l}) (for example, a remaining

$$⌊ \frac{{K}_{NZ}^{tot}}{2} ⌋$$

lowest priority bits).

As described herein, for a given CSI report, group 0 may have a highest priority, followed by group 1, followed by group 2. For example, in FIG. 5, reference number 510 indicates a CSI part 2 packing order that a UE may apply when generating a single CSI report. As shown, a UE may include content (for example, may pack the CSI report) with content associated with group 0 first, followed by content associated with group 1 (for example, if there is sufficient space in the uplink resource allocation after packing all of the content associated with group 0), followed by content associated with group 2 (for example, if there is sufficient space in the uplink resource allocation after packing all of the content associated with group 0 and all of the content associated with group 1). Additionally or alternatively, the CSI packing with omission rules may be associated with a CSI omission order. For example, as shown by reference number 520 in FIG. 5, the CSI omission order may be associated with an index value associated with CSI reports. For example, a CSI report 0 may have a higher priority than a CSI report 1, a CSI report 1 may have a higher priority than a CSI report 2, and so on. Additionally, the CSI omission order may be associated with the groups of content associated with a given CSI report, as described above. For example, across multiple CSI reports, payloads that include content associated with group 0 are packed together and have a priority 0, and payloads that include content associated with group 1 and group 2 are associated with priority 1, 2, . . . , 2Nᵣₑₚₒᵣₜ−1, 2Nᵣₑₚₒᵣₜ, where Nᵣₑₚₒᵣₜ is the total quantity of CSI reports.

For example, assuming that a PUSCH resource is associated with two CSI reports (for example, a CSI report 1 and a CSI report 2), the omission order for dropping or omitting information from the CSI part 2 carried via the PUSCH resource may follow the omission rules depicted in FIG. 5. For example, the omission rules may indicate that information associated with group 2 for CSI report 2 (or information associated with odd subbands for the CSI report 2) is to be omitted or dropped first. The omission rules may indicate that information associated with group 1 for CSI report 2 (or information associated with even subbands for the CSI report 2) is to be omitted or dropped second. The omission rules may indicate that information associated with group 2 for CSI report 1 (or information associated with odd subbands for the CSI report 1) is to be omitted or dropped third. The omission rules may indicate that information associated with group 1 for CSI report 1 (or information associated with even subbands for the CSI report 1) is to be omitted or dropped fourth. The omission rules may indicate that information associated with group 0 for all CSI reports is to be omitted or dropped fifth (or last). Following the omission rules for CSI part 2 may enable the UE to include the more important information in a CSI report when the PUSCH resource allocated for the CSI report is insufficient to indicate all information associated with the CSI report.

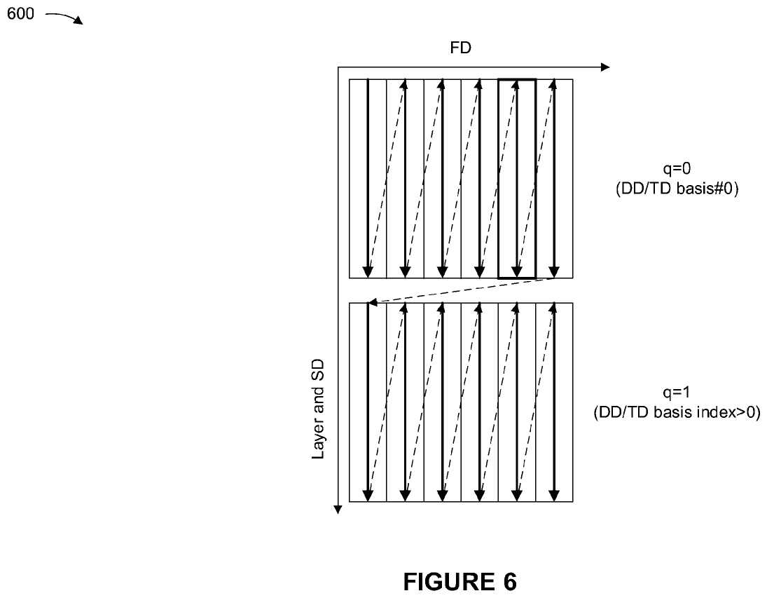

FIG. 6 is a diagram illustrating an example 600 of priority ordering for a coefficient matrix in accordance with the present disclosure. For example, referring to FIG. 6, the horizontal axis corresponds to a frequency domain (FD), and the vertical axis corresponds to layers in a spatial domain (SD). In general, as shown by the thick arrows in FIG. 6, a packing order for the coefficients in the coefficient matrix may start with layer 0 and SD 0 associated with FD 0 and may then progress to a next FD (for example, as shown by the dashed lines in FIG. 6) after all of the coefficients associated with FD 0 have been packed. In other words, both the coefficients and the bitmap are ordered from a high priority to a low priority according to a priority (l, i, m), where l is a layer index, i is a spatial domain basis index, and m is a frequency domain basis index. Furthermore, in the context of CSI omission for extrapolated or predicted CSI that includes one or more time domain bases, a \tilde{W}₂ coefficient packing order can be such that coefficients for Doppler domain basis 0 are packed first, followed by coefficients for Doppler domain bases greater than 0. For example, in some aspects, the coefficients and the bitmap may be ordered from a high priority to a low priority according to a priority (λ, l, m, q), where λ is a layer index, l is a spatial domain index, m is a frequency domain basis index, and q is a Doppler domain or time domain basis index. Furthermore, the selected quantity of time domain bases for each layer is Q=2, where a Doppler domain basis with index 0 is always selected for each layer, and a UE needs to report only another selected Doppler domain basis with an index greater than zero from indices {1, . . . , N₄−1}. For example, in FIG. 6, the first half of the \tilde{W}₂ coefficients are associated with q=0, corresponding to a Doppler or time domain basis with index 0, and the second half of the \tilde{W}₂ coefficients are associated with q=1, corresponding to a Doppler or time domain basis with an index greater than 0.

Accordingly, in cases where the UE reports and the network node receives the first half of the \tilde{W}₂ coefficients associated with the Doppler domain basis with index 0 (for example, the second half of the \tilde{W}₂ coefficients associated with a Doppler domain basis with an index greater than 0, which are included in group 2 of CSI part 2, are omitted due to the CSI omission rules described above with reference to FIG. 5), the network node may still have a capability to derive a workable precoder from the coefficients associated with the Doppler domain basis with index 0. However, when the network node only receives the coefficients related to the Doppler domain basis with index 0 due to CSI omission, the coefficients are time-constant (similar to legacy CSI that is considered to be constant over time). Accordingly, in such cases, including certain content that is time-variant or otherwise specific to the time domain in the CSI part 2, such as extrapolated or predicted precoders associated with a future time window, may result in unnecessary overhead.

Various aspects relate generally to associating CSI content associated with a time domain (for example, time-variant CSI) and/or CSI content that is independent of a time domain (for example, time-constant CSI) with CSI part 1 and/or different groups within CSI part 2 such that certain time-variant CSI content may be omitted from CSI part 2 first (for example, when a UE only reports coefficients related to a Doppler domain with index 0, or time-constant CSI, to a network node). Some aspects more specifically relate to associating content related to a Doppler domain basis selection, content related to a \tilde{W}₂ coefficient quantization associated with a Doppler domain basis with an index greater than 0, content related to a \tilde{W}₂ NZC selection bitmap associated with a Doppler domain basis index greater than 0, and/or content related to a CQI for a slot other than the first slot of a CSI window with group 2 of CSI part 2. In some examples, in cases where an uplink resource allocation for CSI part 2 is insufficient to carry all of the CSI content that the UE extrapolates or predicts for the CSI window, the time-variant CSI content associated with group 2 of CSI part 2 may be packed last and/or omitted first. Furthermore, in some examples, some extrapolated or predicted CSI content may be included in group 1 of CSI part 2, or group 0 of CSI part 2, or in CSI part 1, depending on the relative importance, relevance, and/or payload size of the CSI content.

Particular aspects of the subject matter described in this disclosure can be implemented to realize one or more of the following potential advantages. In some examples, the described techniques can be used to reduce the overhead associated with a CSI report in which some CSI content is time-constant (for example, associated with a Doppler domain basis selection with index 0) and/or certain time-variant CSI content is omitted from the CSI report (for example, CSI content associated with a Doppler domain basis selection with an index greater than 0). For example, when the UE omits time-variant CSI content from the CSI report in accordance with one or more CSI omission rules due to an uplink resource allocation being insufficient to carry all of the content associated with CSI part 2, payloads to carry the time-variant content that is only relevant to future Doppler domain bases may be omitted from the CSI report may be wasteful (for example, are not usable by the network node because the relevant coefficients were omitted). In this way, associating the time-variant CSI content with group 2 of CSI part 2 may result in the time-variant CSI content being omitted first, which may conserve resources that would otherwise be wasted by conveying the irrelevant time-varying content from the UE to the network node.

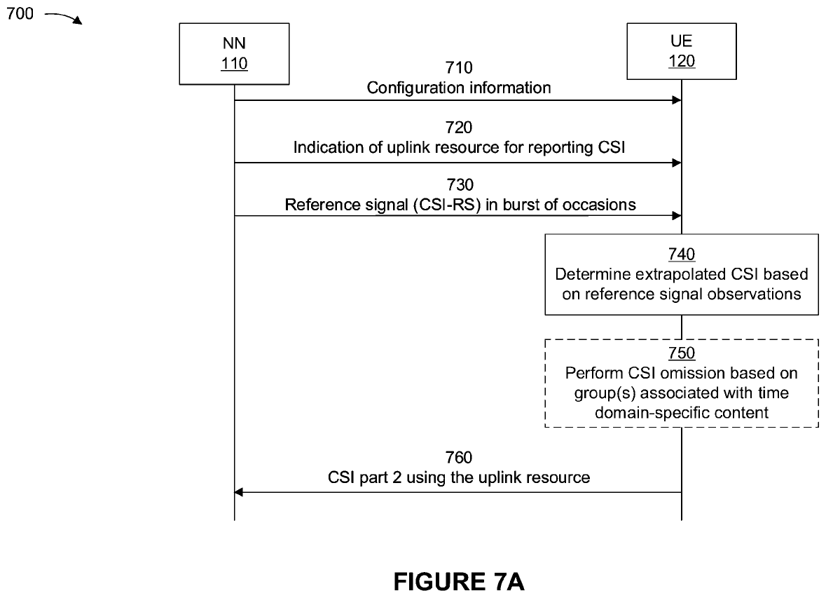

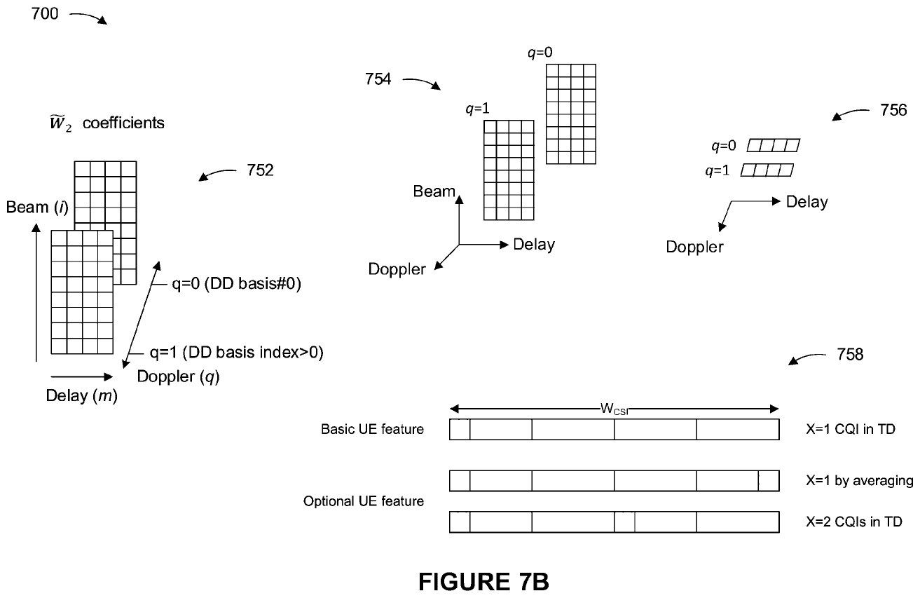

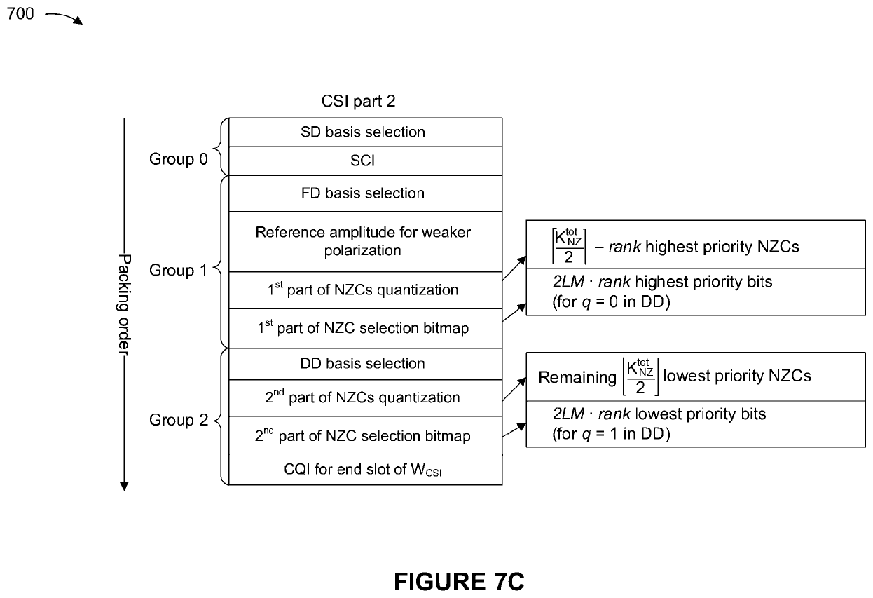

FIGS. 7A-7C are diagrams illustrating an example 700 of a time-constant and time-varying split for Doppler CSI in accordance with the present disclosure. As shown in FIG. 7A, a network node 110 (for example, a CU, a DU, and/or an RU) may communicate with a UE 120. In some aspects, the network node 110 and the UE 120 may be part of a wireless network (for example, the wireless network 100). The UE 120 and the network node 110 may have established a wireless connection prior to operations shown in FIG. 7A.

As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 7A, in a first operation 710, the network node 110 may transmit, and the UE 120 may receive, configuration information. In some aspects, the UE 120 may receive the configuration information via RRC signaling, a MAC-CE, and/or DCI, among other examples. In some aspects, the configuration information may include an indication of one or more configuration parameters (for example, stored by the UE 120 or previously indicated by the network node 110 or other network device) for selection by the UE 120, or explicit configuration information for the UE 120 to use to configure itself.

In some aspects, the configuration information may be associated with a CSI configuration or a CSI-RS configuration. For example, the UE 120 may be configured with one or more non-zero power (NZP) CSI-RS resource set configurations as indicated by higher layer parameters CSI-ResourceConfig, and NZP-CSI-RS-ResourceSet. In some aspects, the configuration may be associated with a codebook configuration. For example, the UE 120 may be configured with a higher layer parameter codebookType. The codebook configuration may indicate a type of codebook to be used by the UE 120 for CSI reporting or PMI reporting. For example, the configuration may indicate that the codebook type is a time domain basis codebook or a Doppler domain basis codebook (for example, as described above with reference to FIG. 3C).

In some aspects, the configuration information may indicate values of one or more parameters associated with CSI reporting or PMI reporting. For example, the UE 120 may be configured with a higher layer parameter paramCombination indicating values for β, Pᵥ, or L, among other examples. As another example, the UE 120 may be configured with numberOfPMI-SubbandsPerCQI-Subband. As described elsewhere herein, this parameter may control a total quantity of precoding matrices N₃ indicated by the PMI as a function of the quantity of configured subbands in csi-ReportingBand, the subband size configured by the higher-level parameter subbandSize and of the total quantity of PRBs in the bandwidth part associated with the UE 120. In some aspects, the UE 120 may be configured with a quantity of time domain bases or Doppler domain bases, N₄, to be associated with the codebook (for example, via a higher layer parameter or an RRC parameter).

In some aspects, the configuration information may indicate that the UE 120 is to report CSI or a PMI for spatial domain basis index values, frequency domain basis index values, and Doppler domain (or time domain) basis index values. For example, the configuration information may indicate that the UE 120 is configured with a codebook that is associated with time domain basis index values and coefficients. For example, the higher layer parameter codebookType may indicate that the UE 120 is configured with a time domain basis codebook in which a time domain basis is commonly selected for all spatial domain bases and frequency domain bases (for example,

$$( {W}_{f}^{*} ⊗ {W}_{1} ) {W}_{2} {W}_{t}^{H} ,$$

$$( {W}_{f} ⊗ {W}_{1} ) {W}_{2} {W}_{t}^{H} , {W}_{1} {{W}_{2} ( {W}_{t} ⊗ {W}_{f} )}^{H} or {W}_{1} {{W}_{2} ( {W}_{f} ⊗ {W}_{t} )}^{H} ,$$

where Wₜ is the time domain bases for the channel) or a codebook associated with a time domain basis may be independently selected for different spatial domain bases and frequency domain bases.

As another example, the configuration information may indicate that the codebook is a Doppler domain basis codebook. For example, the Doppler domain may be associated with, or may correlate to, the time domain (whereas the delay domain may be associated with, or correlate to, the frequency domain). For example, the codebook may be associated with a commonly selected Doppler domain basis for all spatial domain bases and frequency domain bases (for example,

$$( {W}_{f}^{*} ⊗ {W}_{1} ) {W}_{2} {W}_{d}^{H} , ( {W}_{f} ⊗ {W}_{1} ) {W}_{2} {W}_{d}^{H} ,$$

$${W}_{1} {{W}_{2} ( {W}_{d} ⊗ {W}_{f} )}^{H} or {W}_{1} {{W}_{2} ( {W}_{f} ⊗ {W}_{d} )}^{H} ,$$

where W_{d} is the Doppler domain bases for the channel). As another example, a Doppler domain basis may be independently selected for different spatial domain bases and frequency domain bases. In some other examples, the configuration information may indicate that an eType-II codebook associated with time domain bases is to be used by the UE 120.

In some aspects, the configuration information may indicate a part (for example, part 1 or part 2) of CSI or UCI that is associated with the time domain bases. In some other aspects, the part (for example, part 1 or part 2) of CSI or UCI associated with the time domain bases may be defined, or otherwise fixed, by a wireless communication standard, such as the 3GPP (for example, and not indicated in the configuration information). In some aspects, the time domain bases may be included in the CSI (or UCI) part 2 (for example, CSI part 2 as described in more detail elsewhere herein). For example, the UE 120 may be configured to select time domain basis for all layers (for example, from layer 0 to layer RI−1). The time domain basis selections for all layers may be associated with the CSI (or UCI) part 2. Other content associated with CSI (or UCI) part 1 and CSI (or UCI) part 2 may be similar, or the same, as described elsewhere herein. Additionally or alternatively, the configuration information may indicate a group (for example, group 0, group 1, or group 2) associated with time-variant content (for example, extrapolated or predicted CSI content) that is included or otherwise associated with CSI part 2. In some other aspects, the group (for example, group 0, group 1, or group 2 of CSI part 2) associated with the time-variant content may be defined, or otherwise fixed, by a wireless communication standard, such as the 3GPP.

In some aspects, the UE 120 may transmit, and the network node 110 may receive, a capability report. In some aspects, the capability report may indicate UE support for a time domain basis codebook or a Doppler domain basis codebook, as described above. For example, the UE 120 may indicate support for performing time domain basis selection for CSI or PMI reporting in the manner described above with reference to FIG. 3C. In some aspects, the configuration information may be based at least in part on the capability report. For example, the UE 120 may be configured with a time domain basis codebook or a Doppler domain basis codebook for CSI reporting responsive to the capability report indicating that the UE 120 supports the time domain basis codebook or the Doppler domain basis codebook. In some aspects, the UE 120 may configure itself based at least in part on the configuration information. In some aspects, the UE 120 may be configured to perform one or more operations described herein based at least in part on the configuration information.

In some aspects, in a second operation 720, the network node 110 may transmit, and the UE 120 may receive, an indication of an uplink resource associated with reporting CSI. For example, the uplink resource may be a PUSCH resource. For example, the UE 120 may perform aperiodic CSI reporting using the PUSCH on a serving cell associated with the network node 110 upon successful decoding of DCI (for example, DCI associated with a DCI format 0_1 or a DCI format 0_2, as defined, or otherwise fixed, by the 3GPP) which triggers an aperiodic CSI trigger state. The aperiodic CSI trigger state may be configured for the UE 120 via the configuration information. As another example, the UE 120 may perform semi-persistent CSI reporting on the PUSCH based at least in part on successfully decoding of DCI (for example, DCI associated with the DCI format 0_1 or the DCI format 0_2) which activates a semi-persistent CSI trigger state. The semi-persistent CSI trigger state(s) may be configured for the UE 120 via the configuration information. The DCI may contain a CSI request field which indicates the semi-persistent CSI trigger state to activate or deactivate.

As described elsewhere herein, for CSI feedback on the PUSCH, a CSI report may include two parts. CSI part 1 may have a fixed payload size and may be used to identify the quantity of information bits in CSI part 2. The UE 120 may transmit an entirety of CSI part 1 prior to transmitting CSI part 2. CSI part 1 may include an indication of an RI (if reported), a CQI, and an indication of the overall quantity of non-zero amplitude coefficients across layers. The fields of CSI part 1 (for example, the RI if reported, the CQI, and the indication of the overall quantity of non-zero amplitude coefficients across layers) may be separately encoded (from CSI part 2) by the UE 120. CSI part 2 may include an indication of the PMI. For example, CSI part 2 may include time domain basis indices and coefficients. Additionally, CSI part 2 may include a spatial domain subset indicator (SD basis indicator) indicating the selected spatial domain basis vectors (i_{1,1}, i_{1,2}) (for example, the selected beams) for the RI layers of the precoding matrix, a frequency domain subset indicator indicating, for each layer (0 to RI−1), the selected frequency domain basis vectors (i_{1,5} and i_{1,6,l}), an SCI for each layer (0 to RI−1) indicating the SD basis index (or the SD and frequency domain basis indices) associated with the strongest coefficient (i_{1,8,l}), a bitmap per layer indicating the time domain basis indices, spatial domain basis indices, and frequency domain basis indices associated with the NZCs for each layer (i_{1,7,l}), and/or a quantization of the selected NZCs (i_{2,3,l}, i_{2,4,l}, i_{2,5,l}), among other examples.

In some aspects, in a third operation 730, the network node 110 may transmit, and the UE 120 may receive, a reference signal (for example, a downlink reference signal). For example, the reference signal may be a CSI-RS, among other examples. The CSI-RS may be an aperiodic CSI-RS, a semi-persistent CSI-RS, or a periodic CSI-RS that is transmitted in a burst of CSI-RS occasions (for example, a plurality of CSI-RS occasions that occur within a threshold time period). The UE 120 may measure the CSI-RS in the burst of CSI-RS occasions to generate a plurality of CSI-RS observations. In a fourth operation 740, the UE 120 may determine CSI or PMI information associated with the reference signal measurements in the burst of CSI-RS occasions, where the CSI or PMI information may include extrapolated or predicted precoders over a future time window, which are then compressed into a Doppler domain, as described in further detail elsewhere herein (for example, with reference to FIG. 3C). For example, the UE 120 may perform measurements associated with various spatial domain basis candidates or frequency domain basis candidates as indicated by the codebook associated with the CSI reporting. The UE 120 may select spatial domain bases or frequency domain bases in accordance with the measurements. Additionally, the UE 120 may select one or more time domain or Doppler domain bases. For example, the UE 120 may observe (for example, measure) a plurality of time instances (for example, bases) of the PMI. The UE 120 may then extrapolate one or more other time instances (for example, bases) of the PMI based at least in part on the observed time instances.

In a fifth operation 750, the UE 120 may perform CSI omission responsive to a determination that the uplink resource (for example, indicated by the network node 110 in the second operation 720) is insufficient to carry all of the CSI content generated by the UE 120. As used herein, an uplink resource being “insufficient” may refer to the uplink resource not being large enough to carry all information associated with one or more CSI reports that are to be transmitted via the uplink resource. For example, uplink resource allocation (for example, the PUSCH resource allocation) may not be sufficient to carry the entire content of one or more CSI reports. For example, CSI omission may occur when the network node 110 did not accurately or sufficiently allocate the PUSCH resources when scheduling the CSI report(s). For example, the network node may allocate resources for a rank-1 (RI=1) CSI report, but the UE may determine a rank-2 transmission and report a rank-2 (RI=2) CSI report with a size that exceeds the size of the allocated PUSCH resources. In other words, the network node 110 may not know the RI value that will be selected by the UE 120 when the network node 110 allocates the uplink resources for the CSI report(s). Therefore, in some cases, the allocated uplink resources may not be sufficient (for example, may not be large enough) to carry the entire content of the CSI report(s). In such example, the UE 120 may omit some information from one or more CSI reports to enable the UE 120 to transmit other information via the insufficient uplink resource. When CSI reporting on a PUSCH includes two parts, the UE 120 may omit a portion of the CSI part 2. Omission of the CSI part 2 may be performed according to a priority order of one or more groups associated with the CSI part 2.

For example, the groups may be associated with respective priority levels. When omitting content associated with CSI part 2 for a particular priority level, the UE 120 may omit all of the information at that priority level. For example, the one or more groups may include a first group (for example, group 0) that is associated with spatial domain beam index values and strongest coefficient index values (for example, indices i_{1,1} (if reported), i_{1,2} (if reported) and i_{1,8,l}), a second group (for example, group 1) that is associated with frequency domain basis index values and a first portion of the NZCs of the coefficient matrix \tilde{W}₂ associated with a Doppler domain basis with index 0, and the first half of an NZC selection bitmap associated with the Doppler domain basis with index 0. Furthermore, as described herein, the one or more groups may include a third group (for example, group 2) that is generally packed in a CSI report last (for example, in the case of a single CSI report) or omitted first (for example, in the case of multiple CSI reports) when the uplink resource allocated by the network node 110 is insufficient to carry all of the CSI content generated by the UE 120.

For example, in some aspects, the content that is associated with group 2 of CSI part 2 (and therefore packed last or omitted first) may include a Doppler domain basis selection (for example, used to select a Doppler domain basis with an index greater than zero out of N₄−1 Doppler domain bases using ┌log₂(N₄−1)┐ bits). As described herein, a time domain basis selection and a Doppler domain basis selection are a Fourier transform pair, whereby any references herein to a Doppler domain basis selection and a time domain basis selection may be handled in the same or a similar manner. In general, because the Doppler domain basis with index 0 is always selected for each layer, the UE 120 may need to select only one additional Doppler domain basis (with an index greater than 0) from the Doppler domain bases with indexes from 1 to N₄−1. Alternatively, in some cases, the Doppler domain basis selection may be associated with group 1 of CSI part 2 (and therefore packed after group 0 or omitted after group 2) because the Doppler domain basis selection typically has a relatively small payload (for example, ┌log₂(N₄−1)┐ bits, which corresponds to a maximum of 3 bits because N₄≤8).

Additionally or alternatively, the content that is associated with group 2 of CSI part 2 (and therefore packed last or omitted first) may include at least a portion of the coefficient matrix \tilde{W}₂ that indicates a coefficient quantization associated with one or more Doppler domain bases with an index greater than 0. For example, FIG. 7B depicts a coefficient matrix \tilde{W}₂ 752 that includes a first set of coefficients (shown with a gray fill) that corresponds to the Doppler domain basis with index 0 (corresponding to q=0) and a second set of coefficients (shown with a white fill) that corresponds to a Doppler domain basis selection with an index greater than 0 (corresponding to q=1). In this case, the content associated with group 2 of CSI part 2 may include content that indicates the coefficient quantization associated with the Doppler domain basis selection with an index greater than 0 (corresponding to q=1).

For example, in some aspects, the NZCs associated with the coefficient matrix \tilde{W}₂ may be split into two portions, which are each equal to or approximately half of the NZCs in the coefficient matrix \tilde{W}₂, where the first portion may be associated with group 1 of CSI part 2 and the second portion may be associated with group 2 of CSI part 2. For example, in some aspects, the

$$⌈ \frac{{K}_{NZ}^{tot}}{2} ⌉ - rank NZCs$$

with a highest priority may be associated with group 1 of CSI part 2, and the remaining

$$⌊ \frac{{K}_{NZ}^{tot}}{2} ⌋ NZCs$$

with the lowest priority may be associated with group 2 of CSI part 2, where

$${K}_{NZ}^{tot}$$

is the total number of NZCs (for example, reported in CSI part 1). Alternatively, in some aspects, the first portion of the NZCs that are associated with group 1 of CSI part 2 may include NZCs associated with the Doppler domain basis with index 0 (for all layers), and the second portion of the NZCs that are associated with group 2 of CSI part 2 may include NZCs associated with Doppler domain bases greater than 0 (for all layers). Accordingly, in such cases, the NZCs that are associated with group 1 of CSI part 2 only represent a time-constant PMI without including the NZCs associated with group 2 of CSI part 2. Furthermore, in some aspects, an additional

$${K}_{NZ}^{DDbasis \#0}$$

may be included in CSI part 1 (for example, using ┌log₂(2K₀)┐ bits).

Additionally or alternatively, the content that is associated with group 2 of CSI part 2 (and therefore packed last or omitted first) may include at least a portion of the coefficient matrix \tilde{W}₂ that indicates an NZC selection bitmap associated with one or more Doppler domain bases with an index greater than 0. For example, referring to FIG. 7B, reference number 754 depicts a set of bitmaps for indicating the locations of the NZCs, where Q different 2-dimensional (2D) bitmaps are used and each 2D bitmap reuses a legacy bitmap design (for example, a size of the bitmap for each selected Doppler domain basis vector is 2LMv).

For example, as shown by reference number 754 in FIG. 7B, a three-dimensional (3D) bitmap includes a first 2D bitmap that corresponds to the Doppler domain basis with index 0 (corresponding to q=0) and a second 2D bitmap that corresponds to a Doppler domain basis selection with an index greater than 0 (corresponding to q=1). In such cases, the NZC selection bitmap may be split into a first portion that is associated with group 1 of CSI part 2 and a second portion that is associated with group 2 of CSI part 2. For example, in some aspects, the first portion of the NZC selection that is associated with group 1 may include

$$2 LMQ \cdot rank - ⌊ \frac{{K}_{NZ}^{tot}}{2} ⌋ bits ,$$

and the second portion of the NZC selection bitmap that is associated with group 2 may include

$$⌊ \frac{{K}_{NZ}^{tot}}{2} ⌋ bits$$

(for example, similar to a legacy approach for time-constant CSI).

Alternatively, because Q=2 (the UE 120 is configured to report CSI associated with up to two Doppler domain bases),

$$2 LM \frac{Q}{2} \cdot rank = 2 LM \cdot rank bits$$

are included in either group 1 or group 2 of CSI part 2 for the NZC selection bitmap associated with the Doppler domain basis with index 0 (corresponding to q=0) and the selected Doppler domain basis with an index greater than 0 (corresponding to q=1), respectively. In other words, the NZC selection bitmap associated with the Doppler domain basis with index 0 is reported in group 1 of CSI part 2, and the NZC selection bitmap associated with a Doppler domain basis with an index greater than 0 is reported in group 2 of CSI part 2. In this case, 2LM bits may be included per layer for each group, or a subset of 2 LM bits may be included for each layer, based on a rule (for example, a “rhombus” with an SCI as a center).

Additionally or alternatively, reference number 756 in FIG. 7B illustrates an example where the bitmap(s) used to indicate the NZC locations include a first 2D bitmap of size MQ that is used to report S selected pairs of frequency domain and Doppler domain basis vectors and a second 2D bitmap of size 2LS that is used for indicating the location of the NZCs, where each row corresponds to a selected spatial domain basis vector and each column corresponds to one of the S selected pairs of frequency domain and Doppler domain basis vectors. In such cases, in a first example, all MQ·rank bits associated with the first bitmap and all 2LS·rank bits associated with the second bitmap may be associated with group 1 of CSI part 2, and none of the bits are associated with group 2 of CSI part 2. Alternatively, group 1 of CSI part 2 may include the MQ·rank bits associated with the first bitmap and

$$2 LS \cdot rank - ⌊ \frac{{K}_{NZ}^{tot}}{2} ⌋$$

bits associated with a first portion of the second bitmap, and group 2 of CSI part 2 may include a remaining portion of the second bitmap that includes

$$⌊ \frac{{K}_{NZ}^{tot}}{2} ⌋$$

bits.

Additionally or alternatively, the content that is associated with group 2 of CSI part 2 (and therefore packed last or omitted first) may include at least a CQI associated with any slot in a CSI window other than the first slot in the CSI window. For example, as described above with reference to FIG. 4, a UE may be configured to report 2 CQIs in a time domain (for example, based on a starting slot and a middle slot of the CSI window). For example, referring to reference number 758 in FIG. 7B, the UE 120 may report one CQI (X=1) in the time domain, in which case the extrapolated or predicted CSI feedback may include a CQI value only for a starting slot in the CSI window. Additionally or alternatively, the UE 120 may report one CQI (X=1) in the time domain by averaging the CQIs of the starting slot/of the CSI window and the ending slot, l+W_{CSI}−1 for the CSI window. Additionally or alternatively, the UE 120 may report two CQIs (X=2) in the time domain, where the two CQIs may correspond to the starting slot/of the CSI window and the middle slot of the CSI window, l+W_{SCI}/2 for the CSI window. Accordingly, in cases where group 2 of CSI part 2 is omitted such that the coefficients reported to the network node 110 are limited to time-constant coefficients, the second CQI corresponding to the middle slot of the CSI window may be wasted information that is not usable by the network node 110 because there is no time series information to associate with the second CQI corresponding to the middle slot of the CSI window. In some aspects, any CQI that is associated with a slot other than the first slot of the CSI window (such as a CQI associated with the middle slot of the CSI window) may therefore be associated with group 2 of CSI part 2 and therefore omitted along with other content included in group 2 of CSI part 2.

For example, in cases where the UE 120 is configured to report 2 CQIs in the time domain and the second CQI is reported independently from the first CQI or different from the first CQI, the second CQI (for example, at least subband CQIs in a frequency domain) may be associated with group 2 of CSI part 2. Alternatively, in some aspects, the second CQI in the time domain may be associated with CSI part 1 or group 0 of CSI part 2 (and therefore not omitted or omitted last). For example, where the second CQI in the time domain indicates a wideband CQI, the wideband CQI may be associated with CSI part 1 or group 0 of CSI part 2 because the wideband CQI is generally associated with a small payload size, while one or more subband CQIs may be associated with group 2 of CSI part 2. Alternatively, in some aspects, both the wideband CQI and the sub-band CQI(s) may be associated with CSI part 1 or with group 0 of CSI part 2. In some aspects, the wideband CQI and/or the subband CQI(s) may be packed in CSI part 1 or group 0 of CSI part 2 in cases where the \tilde{W}₂ coefficients are not packed with a Doppler domain basis, but a frequency domain is still used as an outermost indexing (for example, the PMI is still time-varying and may need time domain CQIs, whereby CQI should have a higher priority). Additionally or alternatively, in cases where the UE 120 is configured to report 1 CQI in the time domain (for example, when configured to report only a single-slot CQI or one CQI by averaging a CQI of a starting and ending slot of a CSI window), all wideband and subband CQIs in a frequency domain may be reported in CSI part 1 (for example, following legacy rules for reporting time-constant CSI).

Accordingly, in the fifth operation 750 of FIG. 7A, the UE 120 may perform CSI omission (for example, considering the time-variant CSI content included in the various groups of CSI part 2) responsive to the uplink resource to be used to transmit the CSI being insufficient. For example, a size of the uplink resource may be insufficient to carry all content generated for the CSI report. In such examples, the UE 120 may include CSI content in an order (for example, a packing order) of first including information associated with the first group (for example, group 0 of CSI part 2), second including content associated with the second group (for example, group 1 of CSI part 2), and third (for example, last) including content associated with the third group (for example, group 2 of CSI part 2). In other words, the UE 120 may omit information associated with at least one group from the one or more groups based at least in part on prioritizing the one or more groups (for example, prioritizing the first group over the second group and the third group and prioritizing the second group over the third group).

In some aspects, the uplink resource (for example, the PUSCH) resource may be associated with multiple CSI reports. In such examples, the UE 120 may omit information associated with one or more of the CSI reports based at least in part on prioritizing CSI reports, from the multiple CSI reports, in an order of index values of the multiple CSI reports. For example, in addition to prioritizing the groups of a given CSI report, the UE 120 may also prioritize multiple CSI reports in accordance with the index values. For example, a CSI report 0 may have a higher priority than a CSI report 1, the CSI report 1 may have a higher priority than a CSI report 2, and so on.

In a sixth operation 760, the UE 120 may transmit, and the network node 110 may receive, UCI (for example, indicating information associated with one or more CSI reports) using the uplink resource (for example, that was indicated by the network node 110 in the second operation 720). For example, the UE 120 may transmit UCI including a CSI report that indicates PMI values (for example, basis indices and NZCs, among other examples). The UCI may be associated with one or more groups for packing prioritization for the uplink resource, as explained in more detail elsewhere herein. In some aspects, the UE 120 may refrain from transmitting some information associated with the CSI report based at least in part on performing CSI omission (for example, in the fifth operation 750). For example, the UE 120 may refrain from including one or more content types that are associated with group 2 in accordance with CSI omission rules indicating that CSI content is to be packed in the CSI report(s) in an order in which content associated with group 0 is included in the CSI report first, followed by content associated with group 1 only if there is sufficient remaining space within the uplink allocation after all of the group 0 content has been packed, and further followed by content associated with group 2 only if there is sufficient remaining space within the uplink allocation after all of the group 0 and group 1 content has been packed.

For example, FIG. 7C depicts an example CSI part 2 packing order that may be used for a single CSI report using the content associations described in further detail herein. In the illustrated example, the CSI content that is generated by the UE 120 includes a Doppler domain basis selection and a CQI for an ending slot of a CSI window, which are associated with group 2 of CSI part 2 in the illustrated example (note, however, that the Doppler domain basis selection may be packed in group 1 in some examples, as described elsewhere herein). Accordingly, in cases where the UE 120 omits group 2 of CSI part 2 or does not pack group 2 of CSI part 2 into the CSI report, the Doppler domain basis selection and CQI for the ending slot of the CSI window are omitted from or not packed within the CSI report along with the

$$⌊ \frac{{K}_{NZ}^{tot}}{2} ⌋$$

lowest priority NZCs and 2LM·rank lowest priority bits in the NZC selection bitmap.

The network node 110 may determine one or more communication parameters for the UE 120 based at least in part on the information included in the CSI report. For example, the network node 110 may determine a precoder based at least in part on the PMI included in the CSI report. The UE 120 and the network node 110 (for example, an RU) may communicate (for example, transmit or receive) communications using the one or more communication parameters determined by the network node 110 or another network node 110 (for example, a DU or a CU).

FIG. 8 is a flowchart illustrating an example process 800 performed, for example, by a UE that supports a time-constant and time-varying split for Doppler CSI in accordance with the present disclosure. Example process 800 is an example where the UE (for example, UE 120) performs operations associated with a time-constant and time-varying split for Doppler CSI.

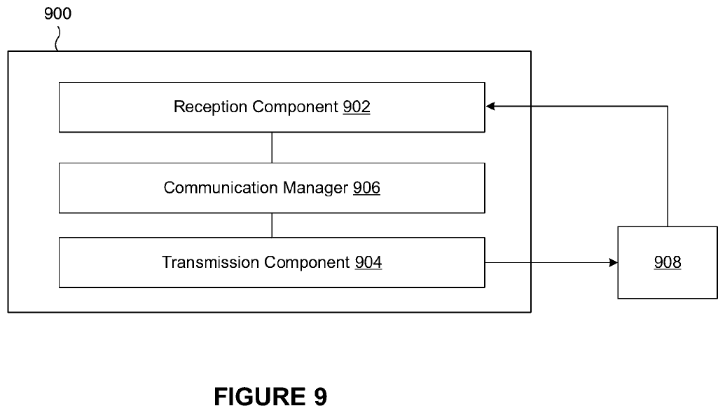

As shown in FIG. 8, in some aspects, process 800 may include receiving a CSI-RS in each of a plurality of CSI-RS occasions (block 810). For example, the UE (such as by using communication manager 906 or reception component 902, depicted in FIG. 9) may receive a CSI-RS in each of a plurality of CSI-RS occasions, as described above.

As further shown in FIG. 8, in some aspects, process 800 may include transmitting, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report (block 820). For example, the UE (such as by using communication manager 906 or transmission component 904, depicted in FIG. 9) may transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report, as described above.

Process 800 may include additional aspects, such as any single aspect or any combination of aspects described below or in connection with one or more other processes described elsewhere herein.

In a first additional aspect, the portion of the second CSI content omitted from the CSI report is associated with group 2 of CSI part 2.

In a second additional aspect, alone or in combination with the first aspect, the portion of the second CSI content omitted from the CSI report includes a Doppler basis for a future time window.

In a third additional aspect, alone or in combination with one or more of the first and second aspects, the portion of the second CSI content omitted from the CSI report includes at least a portion of quantized NZCs associated with a non-zero Doppler basis.

In a fourth additional aspect, alone or in combination with one or more of the first through third aspects, the portion of the quantized NZCs omitted from the CSI report includes half of the quantized NZCs that are associated with a lowest priority.

In a fifth additional aspect, alone or in combination with one or more of the first through fourth aspects, the portion of the quantized NZCs omitted from the CSI report includes a portion of the quantized NZCs associated with a non-zero Doppler basis for a future time window.

In a sixth additional aspect, alone or in combination with one or more of the first through fifth aspects, the portion of the second CSI content omitted from the CSI report includes at least a portion of an NZC selection bitmap associated with a non-zero Doppler basis for a future time window.

In a seventh additional aspect, alone or in combination with one or more of the first through sixth aspects, the portion of the NZC selection bitmap omitted from the CSI report includes a number of bits based at least in part on a rank, a size of the NZC selection bitmap for each Doppler basis, and a number of different bitmaps included in the CSI report.

In an eighth additional aspect, alone or in combination with one or more of the first through seventh aspects, a first NZC selection bitmap associated with a zero Doppler basis is included in group 1 of CSI part 2, and a second NZC selection bitmap associated with a non-zero Doppler basis is included in group 2 of CSI part 2.

In a ninth additional aspect, alone or in combination with one or more of the first through eighth aspects, the portion of the NZC selection bitmap omitted from the CSI report includes a number of bits based at least in part on a rank, a first size of a first bitmap used to report a number of selected pairs of frequency basis vectors and Doppler basis vectors, and a second size of a second bitmap used to report locations of the NZC selections.

In a tenth additional aspect, alone or in combination with one or more of the first through ninth aspects, the portion of the second CSI content omitted from the CSI report include a CQI for one or more slots other than an initial slot in a CSI window.

In an eleventh additional aspect, alone or in combination with one or more of the first through tenth aspects, the CQI omitted from the CSI report includes one or more subband CQIs in a frequency domain.

In a twelfth additional aspect, alone or in combination with one or more of the first through eleventh aspects, one or more Doppler basis selections are included in group 1 of the CSI report.

In a thirteenth additional aspect, alone or in combination with one or more of the first through twelfth aspects, one or more CQIs in a time domain are included in group 1 or group 0 of the CSI report or in CSI part 1.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports a time-constant and time-varying split for Doppler CSI in accordance with the present disclosure. The apparatus 900 may be a UE, or a UE may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE, a network node, or another wireless communication device) using the reception component 902 and the transmission component 904.

In some aspects, the apparatus 900 may be operable to perform one or more operations described herein in connection with FIGS. 7A-7C. Additionally or alternatively, the apparatus 900 may be operable to perform one or more processes described herein, such as process 800 of FIG. 8. In some aspects, the apparatus 900 may include one or more components of the UE described above in connection with FIG. 2.

The reception component 902 may receive communications, such as reference signals, control information, and/or data communications, from the apparatus 908. The reception component 902 may provide received communications to one or more other components of the apparatus 900, such as the communication manager 906. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, and/or a memory of the UE described above in connection with FIG. 2.

The transmission component 904 may transmit communications, such as reference signals, control information, and/or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, and/or a memory of the UE described above in connection with FIG. 2. In some aspects, the transmission component 904 may be co-located with the reception component 902 in a transceiver.

The communication manager 906 may receive or may cause the reception component 902 to receive a CSI-RS in each of a plurality of CSI-RS occasions. The communication manager 906 may transmit or may cause the transmission component 904 to transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report. In some aspects, the communication manager 906 may perform one or more operations described elsewhere herein as being performed by one or more components of the communication manager 906.

The communication manager 906 may include a controller/processor and/or a memory of the UE described above in connection with FIG. 2. In some aspects, the communication manager 906 includes a set of components. Alternatively, the set of components may be separate and distinct from the communication manager 906. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive a CSI-RS in each of a plurality of CSI-RS occasions. The transmission component 904 may transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving a CSI-RS in each of a plurality of CSI-RS occasions; and transmitting, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

Aspect 2: The method of Aspect 1, wherein the portion of the second CSI content omitted from the CSI report is associated with group 2 of CSI part 2.

Aspect 3: The method of any of Aspects 1-2, wherein the portion of the second CSI content omitted from the CSI report includes a Doppler basis for a future time window.

Aspect 4: The method of any of Aspects 1-3, wherein the portion of the second CSI content omitted from the CSI report includes at least a portion of quantized NZCs associated with a non-zero Doppler basis.

Aspect 5: The method of Aspect 4, wherein the portion of the quantized NZCs omitted from the CSI report includes half of the quantized NZCs that are associated with a lowest priority.

Aspect 6: The method of Aspect 4, wherein the portion of the quantized NZCs omitted from the CSI report includes a portion of the quantized NZCs associated with a non-zero Doppler basis for a future time window.

Aspect 7: The method of any of Aspects 1-6, wherein the portion of the second CSI content omitted from the CSI report includes at least a portion of a NZC selection bitmap associated with a non-zero Doppler basis for a future time window.

Aspect 8: The method of Aspect 7, wherein the portion of the NZC selection bitmap omitted from the CSI report includes a number of bits based at least in part on a rank, a size of the NZC selection bitmap for each Doppler basis, and a number of different bitmaps included in the CSI report.

Aspect 9: The method of Aspect 7, wherein a first NZC selection bitmap associated with a zero Doppler basis is included in group 1 of CSI part 2, and wherein a second NZC selection bitmap associated with a non-zero Doppler basis is included in group 2 of CSI part 2.

Aspect 10: The method of Aspect 7, wherein the portion of the NZC selection bitmap omitted from the CSI report includes a number of bits based at least in part on a rank, a first size of a first bitmap used to report a number of selected pairs of frequency basis vectors and Doppler basis vectors, and a second size of a second bitmap used to report locations of the NZC selections.

Aspect 11: The method of any of Aspects 1-10, wherein the portion of the second CSI content omitted from the CSI report include a CQI for one or more slots other than an initial slot in a CSI window.

Aspect 12: The method of Aspect 11, wherein the CQI omitted from the CSI report includes one or more subband CQIs in a frequency domain.

Aspect 13: The method of any of Aspects 1-12, wherein one or more Doppler basis selections are included in group 1 of the CSI report.

Aspect 14: The method of any of Aspects 1-13, wherein one or more CQIs in a time domain are included in group 1 or group 0 of the CSI report or in CSI part 1.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor coupled with the at least one memory, the at least one processor operable to cause the UE to:
receive a channel state information (CSI) reference signal (CSI-RS) in each of a plurality of CSI-RS occasions; and
transmit, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

2. The UE of claim 1, wherein the portion of the second CSI content omitted from the CSI report is associated with group 2 of CSI part 2.

3. The UE of claim 1, wherein the portion of the second CSI content omitted from the CSI report includes a Doppler basis for a future time window.

4. The UE of claim 1, wherein the portion of the second CSI content omitted from the CSI report includes at least a portion of quantized non-zero coefficients associated with a non-zero Doppler basis.

5. The UE of claim 4, wherein the portion of the quantized non-zero coefficients omitted from the CSI report includes half of the quantized non-zero coefficients that are associated with a lowest priority.

6. The UE of claim 4, wherein the portion of the quantized non-zero coefficients omitted from the CSI report includes a portion of the quantized non-zero coefficients associated with a non-zero Doppler basis for a future time window.

7. The UE of claim 1, wherein the portion of the second CSI content omitted from the CSI report includes at least a portion of a non-zero coefficient selection bitmap associated with a non-zero Doppler basis for a future time window.

8. The UE of claim 7, wherein the portion of the non-zero coefficient selection bitmap omitted from the CSI report includes a number of bits based at least in part on a rank, a size of the non-zero coefficient selection bitmap for each Doppler basis, and a number of different bitmaps included in the CSI report.

9. The UE of claim 7, wherein a first non-zero coefficient selection bitmap associated with a zero Doppler basis is included in group 1 of CSI part 2, and wherein a second non-zero coefficient selection bitmap associated with a non-zero Doppler basis is included in group 2 of CSI part 2.

10. The UE of claim 7, wherein the portion of the non-zero coefficient selection bitmap omitted from the CSI report includes a number of bits based at least in part on a rank, a first size of a first bitmap used to report a number of selected pairs of frequency basis vectors and Doppler basis vectors, and a second size of a second bitmap used to report locations of the non-zero coefficient selections.

11. The UE of claim 1, wherein the portion of the second CSI content omitted from the CSI report include a channel quality indication (CQI) for one or more slots other than an initial slot in a CSI window.

12. The UE of claim 11, wherein the CQI omitted from the CSI report includes one or more subband CQIs in a frequency domain.

13. The UE of claim 1, wherein one or more Doppler basis selections are included in group 1 of the CSI report.

14. The UE of claim 1, wherein one or more channel quality indicators (CQIs) in a time domain are included in group 1 or group 0 of the CSI report or in CSI part 1.

15. A method of wireless communication performed by a user equipment (UE), comprising:
receiving a channel state information (CSI) reference signal (CSI-RS) in each of a plurality of CSI-RS occasions; and
transmitting, to a network node, a CSI report associated with measurements in the plurality of CSI-RS occasions and associated with one or more time-constant CSI content types, and the CSI report omitting at least a portion of second CSI content associated with measurements in the plurality of CSI-RS occasions and associated with one or more time-varying CSI content types in association with one or more omission rules associated with the CSI report.

16. The method of claim 15, wherein the portion of the second CSI content omitted from the CSI report is associated with group 2 of CSI part 2.

17. The method of claim 15, wherein the portion of the second CSI content omitted from the CSI report includes a Doppler basis for a future time window.

18. The method of claim 15, wherein the portion of the second CSI content omitted from the CSI report includes at least a portion of quantized non-zero coefficients associated with a non-zero Doppler basis.

19. (canceled)

20. (canceled)

21. The method of claim 15, wherein the portion of the second CSI content omitted from the CSI report includes at least a portion of a non-zero coefficient selection bitmap associated with a non-zero Doppler basis for a future time window.

22. (canceled)

23. (canceled)

24. (canceled)

25. The method of claim 15, wherein the portion of the second CSI content omitted from the CSI report include a channel quality indication (CQI) for one or more slots other than an initial slot in a CSI window.

26. (canceled)

27. (canceled)

28. (canceled)

29. (canceled)

30. (canceled)
